(19) United States
(12) Patent Application Publication
(10) Pub. No.: US 2024/0255038 A1
(43) Pub. Date: Aug. 1, 2024

(54) DISC BRAKE

(71) Applicants: HITACHI ASTEMO, LTD., Ibaraki (JP); HONDA MOTOR CO., LTD., Tokyo (JP)

(72) Inventors: Hiroyuki KONO, Hitachinaka-shi (JP); Katsuhiro TAKAHASHI, Hitachinaka-shi (JP); Nobuteru FUJII, Tokyo (JP); Hikaru YADORI, Tokyo (JP)

(21) Appl. No.: 18/422,410

(22) Filed: Jan. 25, 2024

(30) Foreign Application Priority Data
Jan. 31, 2023 (JP) 2023-013324

(51) Int. Cl. F16D 65/12; F16D 65/00; F16D 65/097

(52) U.S. Cl. CPC F16D 65/122; F16D 65/0068; F16D 65/0977

(57) ABSTRACT

A disc brake includes pad springs including a turning-in-side pad spring and a turning-out-side pad spring. The turning-in-side pad spring includes a turning-in-side side pushing spring that generates a first biasing force of biasing, on a turning-out side and in a direction away from the disc in a direction of a rotation axis of the disc, a turning-in-side friction pad portion of each of a pair of friction pads. The turning-out-side pad spring includes a turning-out-side side pushing spring, a second biasing force of which biasing, on a turning-in side and in the direction away from the disc in the direction of the rotation axis of the disc, a turning-out-side friction pad portion of each of the pair of friction pads is smaller than the first biasing force of the turning-in-side side pushing spring.

### BACKGROUND OF THE INVENTION

### Field of the Invention

The present invention relates to a disc brake. Priority is claimed on Japanese Patent Application No. 2023-013324, filed Jan. 31, 2023, the content of which is incorporated herein by reference.

### Description of Related Art

Some disc brakes including friction pads facing rotors and supports that support a braking force from the friction pads use pad clips.

Examples of such background art include Japanese Unexamined Patent Application, First Publication No. 2000-161395.

It is desired to curb dragging in which a friction pad comes into contact with a disc in a brake released state for a disc brake.

### SUMMARY OF THE INVENTION

The present invention provides a disc brake capable of curbing dragging of friction pads.

A first aspect of the disc brake according to the present invention is a disc brake that brakes a disc that rotates along with a wheel of a vehicle. The disc brake includes: an attachment member; a caliper; a pair of friction pads; a return spring; and a pad spring.

The attachment member is fixed to a wheel support portion supporting the wheel and is provided to straddle an outer peripheral side of the disc in a radial direction with respect to a rotation axis of the disc.

The caliper is provided in the attachment member to be movable in a direction of the rotation axis.

The pair of friction pads are provided in the attachment member and are pressed against both side surfaces of the disc by the caliper in the direction of the rotation axis.

The return spring biases the pair of friction pads in a direction away from the disc in the direction of the rotation axis. The return spring includes a turning-in-side return spring and a turning-out-side return spring. The turning-in-side return spring is fixed to a turning-in side of a rear surface of each of the pair of friction pads located on a side opposite to a distal end surface abutting the disc, which the disc enters while rotating in a rotation direction of the disc. The turning-in-side return spring abuts a turning-in-side abutting surface portion of the attachment member on the turning-in side in the direction of the rotation axis. The turning-out-side return spring is fixed to a turning-out side of the rear surface of each of the pair of friction pads, at which the disc exits while rotating in the rotation direction of the disc. The turning-out-side return spring abuts a turning-out-side abutting surface portion of the attachment member on the turning-out side in the direction of the rotation axis.

The pad spring is provided between the attachment member and the pair of friction pads in the rotation direction of the disc. The pad spring includes a turning-in-side pad spring and a turning-out-side pad spring. The turning-in-side pad spring is provided between an attachment portion of the attachment member on the turning-in side and the pair of friction pads and includes a turning-in-side side pushing spring that generates a first biasing force of biasing, on the turning-out side and in a direction of the disc in the direction of the rotation axis, a turning-in-side friction pad portion located at each of the pair of friction pads on the turning-in side. The turning-out-side pad spring is provided between an attachment portion of the attachment member on the turning-out side and the pair of friction pads and includes a turning-out-side side pushing spring, a second biasing force of biasing, on the turning-in side and in the direction of the disc in the direction of the rotation axis, a turning-out-side friction pad portion located at each of the pair of friction pads on the turning-out side being smaller than the first biasing force of the turning-in-side side pushing spring.

A second aspect of the disc brake according to the present invention is a disc brake that brakes a disc that rotates along with a wheel of a vehicle. The disc brake includes: an attachment member; a caliper; a pair of friction pads; a return spring; and a pad spring.

The attachment member is fixed to a wheel support portion supporting the wheel and is provided to straddle an outer peripheral side of the disc in a radial direction with respect to a rotation axis of the disc.

The caliper is provided in the attachment member to be movable in a direction of the rotation axis.

The pair of friction pads are provided in the attachment member and are pressed against both side surfaces of the disc by the caliper in the direction of the rotation axis. The return spring biases the pair of friction pads in a direction away from the disc in the direction of the rotation axis. The return spring includes a turning-in-side return spring and a turning-out-side return spring. The turning-in-side return spring is fixed to a turning-in side of a rear surface of each of the pair of friction pads located on a side opposite to a distal end surface abutting the disc, which the disc enters while rotating in a rotation direction of the disc. The turning-in-side return spring abuts a turning-in-side abutting surface portion of the attachment member on the turning-in side in the direction of the rotation axis. The turning-out-side return spring is fixed to a turning-out side of the rear surface of each of the pair of friction pads, which the disc exits while rotating in the rotation direction of the disc. The turning-out-side return spring abuts a turning-out-side abutting surface portion of the attachment member on the turning-out side in the direction of the rotation axis.

The pad spring is provided between the attachment member and the pair of friction pads in the rotation direction of the disc. The pad spring includes a turning-in-side pad spring and a turning-out-side pad spring. The turning-in-side pad spring is provided between an attachment portion of the attachment member on the turning-in side and the pair of friction pads and includes a turning-in-side side pushing spring that biases, on the turning-out side and in a direction of the disc in the direction of the rotation axis, a turning-in-side friction pad portion located at each of the pair of friction pads on the turning-in side. The turning-out-side pad spring is provided between an attachment portion of the attachment member on the turning-out side and the pair of friction pads. The turning-out-side pad spring includes no spring corresponding to a turning-out-side side pushing spring that biases, on the turning-in side and in the direction of the disc in the direction of the rotation axis, a turning-out-side friction pad portion located at each of the pair of friction pads on the turning-out side.

According to the aforementioned disc brake, it is possible to curb dragging of the friction pads.

### BRIEF DESCRIPTION OF THE DRAWINGS

FIG. 1 is a perspective view illustrating a disc brake according to a first embodiment.

FIG. 2 is a perspective view illustrating the disc brake according to the first embodiment with components of a caliper except for a slide pin removed therefrom.

FIG. 3 is a view of the disc brake according to the first embodiment illustrated with the components of the caliper except for the slide pin removed therefrom when seen from an inner side.

FIG. 4 is a view of the disc brake according to the first embodiment illustrated with the components of the caliper except for the slide pin removed therefrom when seen from an inward side in a disc radial direction.

FIG. 5 is a view of the disc brake according to the first embodiment illustrated with the components of the caliper except for the slide pin removed therefrom when seen from an outward side in the disc radial direction.

FIG. 6 is a view of the disc brake according to the first embodiment illustrated with the caliper removed therefrom when seen from the outer side.

FIG. 7 is a partial view of the disc brake according to the first embodiment except for a turning-in-side return spring and a rivet removed therefrom when seen from the outer side.

FIG. 8 is a perspective view illustrating a turning-in-side pad spring of the disc brake according to the first embodiment.

FIG. 9 is a side view illustrating the turning-in-side pad spring of the disc brake according to the first embodiment.

FIG. 10 is a partial side view illustrating the turning-in-side pad spring of the disc brake according to the first embodiment.

FIG. 11 is a perspective view illustrating a turning-out-side pad spring of the disc brake according to the first embodiment.

FIG. 12 is a side view illustrating the turning-out-side pad spring of the disc brake according to the first embodiment.

FIG. 13 is a view schematically illustrating a first state of the disc brake according to the first embodiment when seen from the outer side.

FIG. 14 is a perspective view of a disc brake according to a second embodiment illustrated with components of a caliper except for a slide pin removed therefrom.

FIG. 15 is a view of the disc brake according to the second embodiment illustrated with components of the caliper except for the slide pin removed therefrom when seen from an outward side in a disc radial direction.

FIG. 16 is a view of the disc brake according to the second embodiment with the components of the caliper except for the slide pin removed therefrom when seen from the inner side.

FIG. 17 is a view of the disc brake according to the second embodiment illustrated with the caliper removed therefrom when seen from the outer side.

FIG. 18 is a side view illustrating a turning-out-side pad spring of the disc brake according to the second embodiment.

### DETAILED DESCRIPTION OF THE INVENTION

### First Embodiment

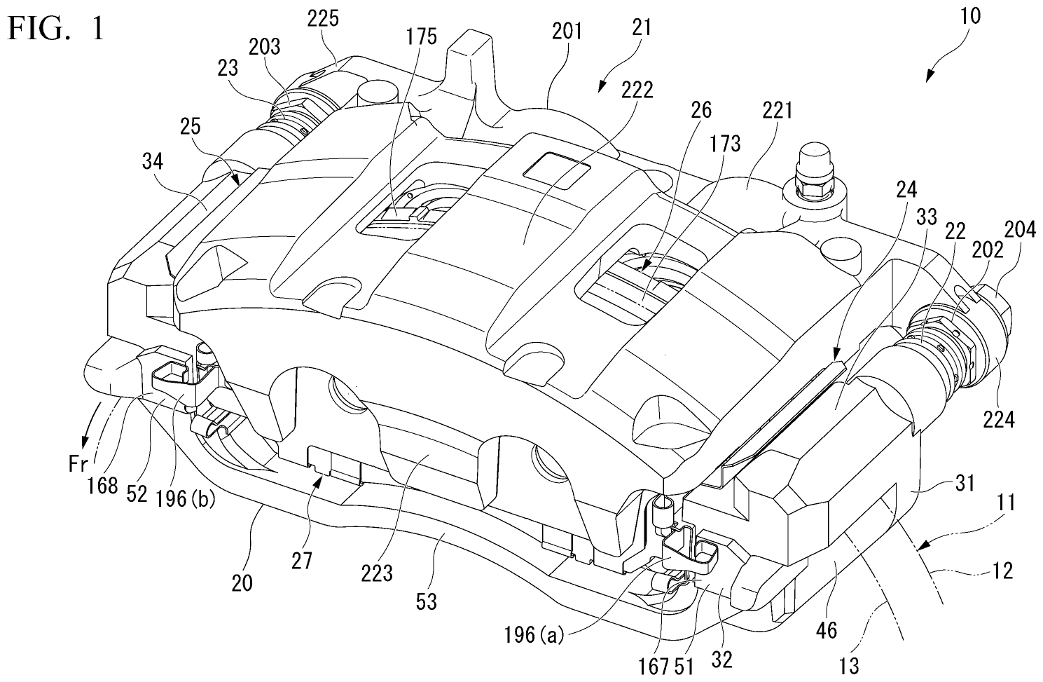

A first embodiment will be described below with reference to FIGS. 1 to 13. A disc brake 10 according to the first embodiment illustrated in FIG. 1 is for a vehicle such as an automobile and applies a braking force to the vehicle.

The disc brake 10 is specifically for braking a four-wheeled automobile. The disc brake 10 brakes a disc-shaped disc 11 that rotates along with one wheel of the vehicle, which is not illustrated.

The disc brake 10 includes an attachment member 20, a caliper 21, a turning-in-side pin boot 22, a turning-out-side pin boot 23, a turning-in-side pad spring 24 (pad spring), a turning-out-side pad spring 25 (pad spring), a first friction pad 26 (friction pad), and a second friction pad 27 (friction pad).

Hereinafter, a center axis of the disc 11, that is, a rotation axis of the disc 11 will be referred to as a disc axis. Also, a direction in which the disc axis extends will be referred to as a disc axis direction. A radial direction with respect to the disc axis of the disc 11 inside the disc brake 10 will be referred to as a disc radial direction. A rotation direction, that is, a circumferential direction of the disc 11 inside the disc brake 10 will be referred to as a disc rotation direction. A side of the center axis of the disc 11 in the disc radial direction will be referred to as an inward side in the disc radial direction. A side opposite to the center axis of the disc 11 in the disc radial direction will be referred to as an outward side in the disc radial direction. A central side of the length in the disc rotation direction inside the disc brake 10 will be referred to as an inward side in the disc rotation direction. A side opposite to the center of the length in the disc rotation direction inside the disc brake 10 will be referred to as an outward side in the disc rotation direction. A line that passes through the disc axis and the center of the attachment member 20 and the caliper 21 in the disc rotation direction and follows the disc radial direction will be referred to as a reference line in the radial direction. The reference line in the radial direction perpendicularly intersects the disc axis. A plane including the reference line in the radial direction and the disc axis will be referred to as a reference plane in the radial direction.

The outward side of the disc brake 10 in the vehicle width direction of the vehicle with the disc brake 10 provided therein will be referred to as an outer side. The inward side of the disc brake 10 in the vehicle width direction of the vehicle with the disc brake 10 provided therein will be referred to as an inner side. An inlet side of the disc brake 10 in a rotation direction Fr of the disc 11 when the vehicle provided with the disc brake 10 travels forward, that is, the side which the disc 11 enters while rotating will be referred to as a turning-in side at the time of forward moving (turning-in side). An outlet side of the disc brake 10 in the rotation direction Fr of the disc 11 when the vehicle provided with the disc brake 10 travels forward, that is, the side which the disc 11 exits while rotating will be referred to as a turning-out side at the time of forward moving (turning-out side). The turning-in side at the time of forward moving corresponds to the outlet side of the disc brake 10 in the rotation direction of the disc 11 when the vehicle provided with the disc brake 10 travels backward. The outlet side of the disc brake 10 in the rotation direction of the disc 11 when the vehicle travels backward will be referred to as a turning-out side at the time of backward moving. The turning-out side at the time of forward moving corresponds to an inlet side of the disc brake 10 in the rotation direction of the disc 11 when the vehicle provided with the disc brake 10 travels backward. The inlet side of the disc brake 10 in the rotation direction of the disc 11 when the vehicle travels backward will be referred to as a turning-in side at the time of backward moving.

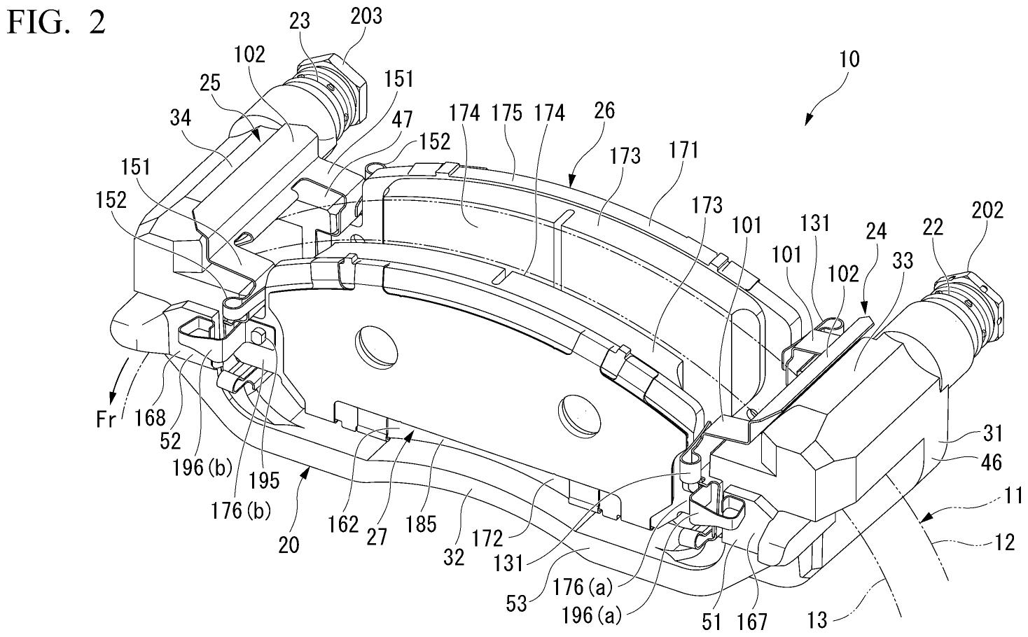

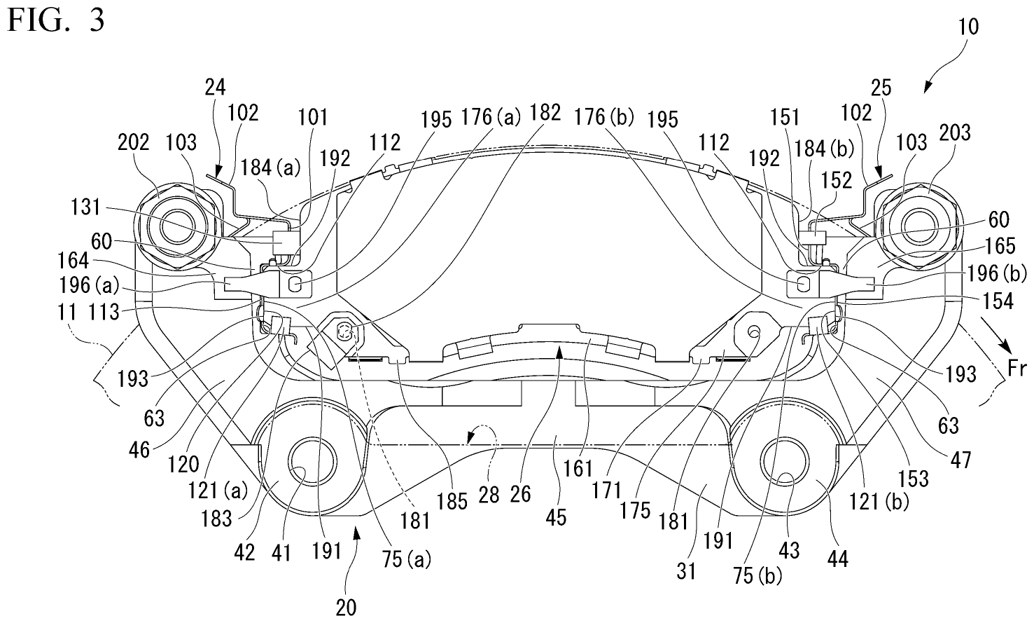

As illustrated in FIG. 2, the attachment member 20 is fixed to a wheel support portion 28 that is illustrated in FIG. 3 and supports a wheel of the vehicle, which is not illustrated, in a state where the wheel support portion 28 straddles an outer peripheral side of the disc 11 in the disc radial direction.

As illustrated in FIG. 2, the attachment member 20 includes an inner-side disposition portion 31, an outer-side disposition portion 32, and a pair of turning-in-side coupling portion 33 and turning-out-side coupling portion 34. The attachment member 20 has a substantially mirror symmetric shape with reference to a reference plane in the radial direction.

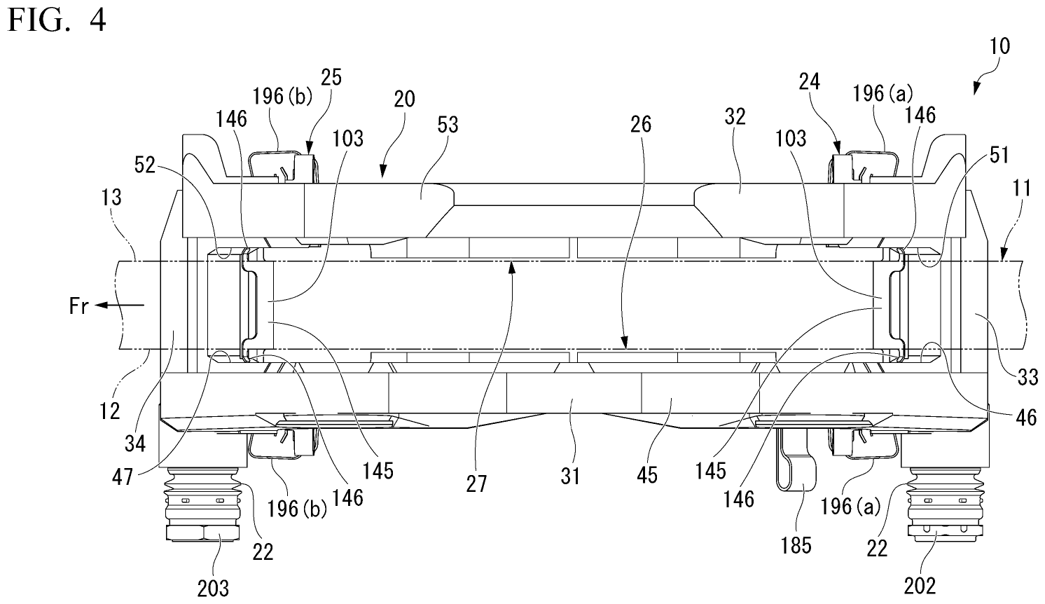

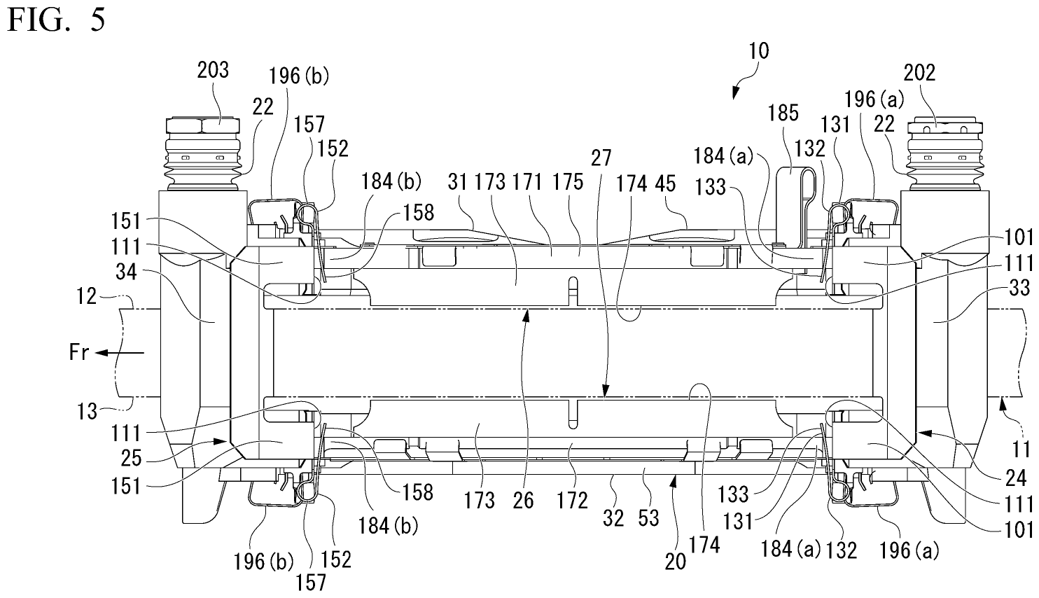

The disc 11 includes a first side surface 12 on one side in the disc axis direction and a second side surface 13 on the other side in the disc axis direction as illustrated in FIGS. 4 and 5. The first side surface 12 is disposed on the inner side of the disc 11. The second side surface 13 is disposed on the outer side of the disc 11.

The inner-side disposition portion 31 is disposed on the one side in the disc axis direction with respect to the disc 11 and is attached to the wheel support portion 28 illustrated in FIG. 3. Here, the wheel support portion 28 to which the attachment member 20 is attached is disposed on the inner side with respect to the disc 11. Therefore, the inner-side disposition portion 31 attached to the wheel support portion 28 is also disposed on the inner side with respect to the disc 11.

As illustrated in FIG. 4, the inner-side disposition portion 31 faces the first side surface 12 of the disc 11. The inner-side disposition portion 31 supports the first friction pad 26 illustrated in FIG. 2 such that the first friction pad 26 is movable in the disc axis direction. In other words, the first friction pad 26 is movable in the disc axis direction. The first friction pad 26 is disposed on the inner side with respect to the disc 11. The first friction pad 26 is disposed to face the first side surface 12 of the disc 11.

The outer-side disposition portion 32 is disposed on the other side in the disc axis direction with respect to the disc 11. The outer-side disposition portion 32 is disposed on the outer side with respect to the disc 11. The outer-side disposition portion 32 faces the second side surface 13 of the disc 11. The outer-side disposition portion 32 supports the second friction pad 27 such that the second friction pad 27 is movable in the disc axis direction. In other words, the second friction pad 27 is movable in the disc axis direction. The second friction pad 27 is disposed on the outer side with respect to the disc 11. The second friction pad 27 is disposed to face the second side surface 13 of the disc 11.

The turning-in-side coupling portion 33 and the turning-out-side coupling portion 34 extend in the disc axis direction and are provided to straddle the outer peripheral side of the disc 11 in the disc axis direction. The turning-in-side coupling portion 33 couples end portions of the inner-side disposition portion 31 and the outer-side disposition portion 32 on the outward side in the disc radial direction and on the turning-in side at the time of forward moving. The turning-out-side coupling portion 34 couples end portions of the inner-side disposition portion 31 and the outer-side disposition portion 32 on the outward side in the disc radial direction and on the turning-out side at the time of forward moving. The attachment member 20 includes the turning-in-side coupling portion 33 provided on the turning-in side at the time of forward moving and the turning-out-side coupling portion 34 provided on the turning-out side at the time of forward moving, out of the turning-in-side coupling portion 33 and the turning-out-side coupling portion 34.

As illustrated in FIG. 3, the inner-side disposition portion 31 includes a turning-in-side fixing portion 42 having a screw hole 41, a turning-out-side fixing portion 44 having a screw hole 43, and a main beam 45 that establishes connection between the turning-in-side fixing portion 42 and the turning-out-side fixing portion 44. The inner-side disposition portion 31 includes a first attachment portion 46 (attachment portion) stretching out from the turning-in-side fixing portion 42 and a second attachment portion 47 (attachment portion) stretching out from the turning-out-side fixing portion 44. All of the turning-in-side fixing portion 42, the turning-out-side fixing portion 44, the main beam 45, the first attachment portion 46, and the second attachment portion 47 are disposed on the inner side with respect to the disc 11, and all of them face the first side surface 12 of the disc 11.

The turning-in-side fixing portion 42 is provided on the turning-in side at the time of forward moving as compared with the turning-out-side fixing portion 44 in the inner-side disposition portion 31. The main beam 45 extends in the disc rotation direction. The screw hole 41 is pierced in the turning-in-side fixing portion 42 in the disc axis direction. The screw hole 43 is pierced in the turning-out-side fixing portion 44 in the disc axis direction. The attachment member 20 is attached to the wheel support portion 28 with bolts that are screwed into the screw holes 41 and 43 and are not illustrated in the drawing, in a state where the turning-in-side fixing portion 42 and the turning-out-side fixing portion 44 are brought into contact with the wheel support portion 28, which is a non-rotating portion of the vehicle. The mutual positions in the disc axis direction and the positions in the disc radial direction of the turning-in-side fixing portion 42 and the turning-out-side fixing portion 44 fixed to the wheel support portion 28, which is a non-rotating portion of the vehicle, are aligned. In this state, the position of the main beam 45 is caused to overlap the turning-in-side fixing portion 42 and the turning-out-side fixing portion 44 in the disc axis direction.

The first attachment portion 46 stretches out on the outward side in the disc radial direction from the turning-in-side fixing portion 42 with its position overlapping the turning-in-side fixing portion 42 in the disc axis direction. The second attachment portion 47 stretches out in the outward side in the disc radial direction from the turning-out-side fixing portion 44 with its position overlapping the turning-out-side fixing portion 44 in the disc axis direction. The first attachment portion 46 is disposed on the turning-in side at the time of forward moving as compared with the second attachment portion 47.

As illustrated in FIG. 2, the turning-in-side coupling portion 33 stretches out in the disc axis direction from an end portion of the first attachment portion 46 on the outward side in the disc radial direction toward the outer side while straddling the further outward side in the disc radial direction as compared with the outer peripheral surface of the disc 11. The turning-out-side coupling portion 34 stretches out in the disc axis direction from an end portion of the second attachment portion 47 on the outward side in the disc radial direction toward the outer side while straddling the further outward side in the disc radial direction as compared with the outer peripheral surface of the disc 11.

The outer-side disposition portion 32 includes a third attachment portion 51 (attachment portion) stretching out from the turning-in-side coupling portion 33, a fourth attachment portion 52 (attachment portion) stretching out from the turning-out-side coupling portion 34, and an outer beam 53 coupling the third attachment portion 51 to the fourth attachment portion 52. All of the third attachment portion 51, the fourth attachment portion 52, and the outer beam 53 are disposed on the outer side with respect to the disc 11, and all of them face the second side surface 13 of the disc 11.

The third attachment portion 51 stretches out inward in the disc radial direction from an end portion of the turning-in-side coupling portion 33 on the outer side in the disc axis direction. The fourth attachment portion 52 stretches out inward in the disc radial direction from an end portion of the turning-out-side coupling portion 34 on the outer side in the disc axis direction. The third attachment portion 51 is disposed on the turning-in side at the time of forward moving as compared with the fourth attachment portion 52. The outer beam 53 couples an end portion of the third attachment portion 51 on the inward side in the disc radial direction to an end portion of the fourth attachment portion 52 on the inward side in the disc radial direction. The outer beam 53 extends in the disc rotation direction.

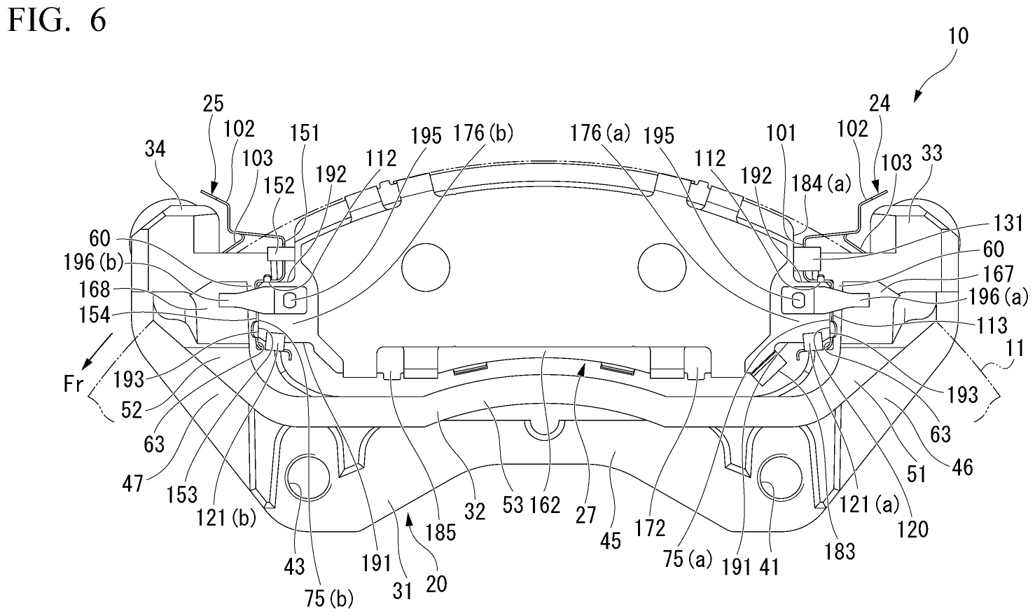

A torque receiving portion 60 with a same shape is formed at each of the first attachment portion 46 and the second attachment portion 47 illustrated in FIG. 3 and the third attachment portion 51 and the fourth attachment portion 52 illustrated in FIG. 6 on the inward side in the disc rotation direction. The torque receiving portion 60 of the first attachment portion 46 and the torque receiving portion 60 of the second attachment portion 47 illustrated in FIG. 3 are disposed in a mirror symmetrical form in the disc rotation direction. The torque receiving portion 60 of the third attachment portion 51 and the torque receiving portion 60 of the fourth attachment portion 52 illustrated in FIG. 6 are disposed in a mirror symmetrical form in the disc rotation direction. In other words, the attachment member 20 has the torque receiving portions 60 on both sides in the disc rotation direction.

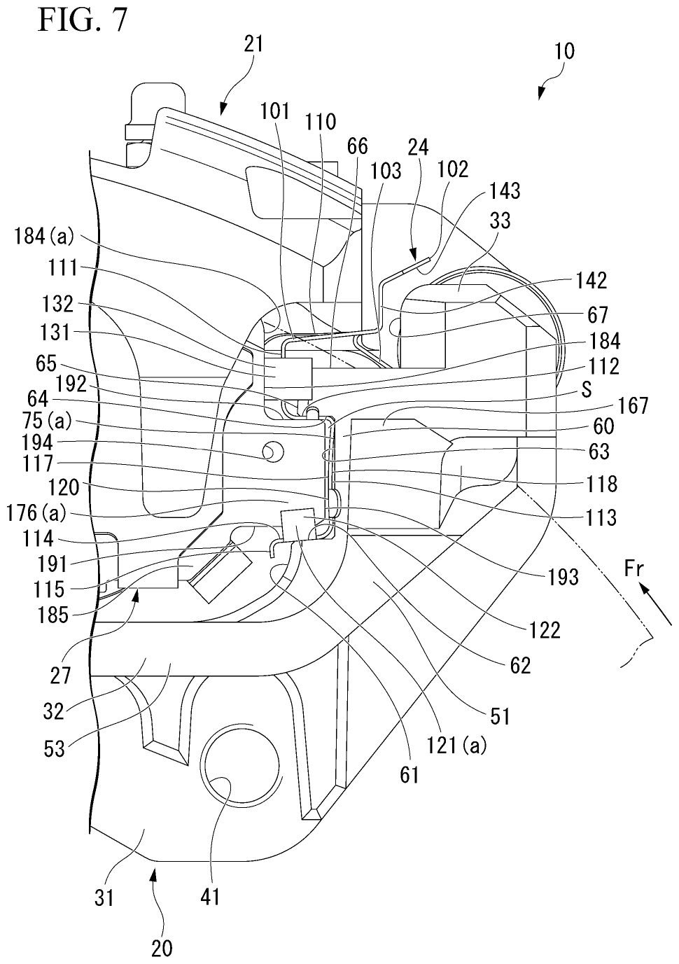

The torque receiving portions 60 provided with the same shapes at the four locations will be described by exemplifying the torque receiving portion 60 of the third attachment portion 51 illustrated in FIG. 7. The torque receiving portion 60 includes a first surface portion 61, a second surface portion 62, a third surface portion 63, a fourth surface portion 64, a fifth surface portion 65, a sixth surface portion 66, and a seventh surface portion 67 in order from the inward side in the disc radial direction. All of the first surface portion 61, the second surface portion 62, the third surface portion 63, the fourth surface portion 64, the fifth surface portion 65, the sixth surface portion 66, and the seventh surface portion 67 spread in the disc axis direction.

The first surface portion 61 has a curved surface shape and follows the disc radial direction.

The second surface portion 62 has a planar shape and stretches out on the outward side in the disc rotation direction from the outward side of the first surface portion 61 in the disc radial direction. The second surface portion 62 spreads substantially perpendicularly to a reference line in the radial direction.

The third surface portion 63 has a planar shape and stretches out on the outward side in the disc radial direction from the outward side of the second surface portion 62 in the disc rotation direction. The third surface portion 63 spreads in parallel with the reference plane in the radial direction.

The fourth surface portion 64 has a planar shape and stretches out on the inward side in the disc rotation direction from the outward side of the third surface portion 63 in the disc radial direction. The fourth surface portion 64 spreads perpendicularly to the reference line in the radial direction.

The fifth surface portion 65 has a planar shape and stretches out on the outward side in the disc radial direction from the inward side of the fourth surface portion 64 in the disc rotation direction. The fifth surface portion 65 spreads in parallel with the reference plane in the radial direction.

The sixth surface portion 66 has a planar shape and stretches out on the outward side in the disc rotation direction from the outward side of the fifth surface portion 65 in the disc radial direction. The sixth surface portion 66 spreads perpendicularly to the reference line in the radial direction.

The seventh surface portion 67 has a planar shape and stretches out on the outward side in the disc radial direction from the outward side of the sixth surface portion 66 in the disc radial direction. The seventh surface portion 67 spreads in parallel with the reference plane in the radial direction.

The first surface portion 61, the third surface portion 63, the fifth surface portion 65, and the seventh surface portion 67 face the inward side in the disc rotation direction. The second surface portion 62 and the sixth surface portion 66 face the outward side in the disc radial direction. The fourth surface portion 64 faces the inward side in the disc radial direction.

The second surface portion 62, the third surface portion 63, and the fourth surface portion 64 that continue configure a turning-in-side ear accommodating portion 75(a) that is recessed on the side further outward than the first surface portion 61 and the fifth surface portion 65 in the disc rotation direction. The torque receiving portion 60 is a torque receiving surface on which the third surface portion 63 of the turning-in-side ear accommodating portion 75(a) receives a braking torque of the second friction pad 27.

As illustrated in FIG. 6, the torque receiving portion 60 of the fourth attachment portion 52 has a turning-out-side ear accommodating portion 75(b) in a mirror symmetrical form with the turning-in-side ear accommodating portion 75(a) of the torque receiving portion 60 of the third attachment portion 51. The turning-in-side ear accommodating portion 75(a) of the third attachment portion 51 and the turning-out-side ear accommodating portion 75(b) of the fourth attachment portion 52 face each other in the disc rotation direction and are recessed in directions separated from each other in the disc rotation direction. The turning-in-side ear accommodating portion 75(a) of the third attachment portion 51 and the turning-out-side ear accommodating portion 75(b) of the fourth attachment portion 52 are located at aligned positions in the disc axis direction and are also located at aligned positions in the disc radial direction. The turning-in-side ear accommodating portion 75(a) of the third attachment portion 51 penetrates through the third attachment portion 51 in the disc axis direction. The turning-out-side ear accommodating portion 75(b) of the fourth attachment portion 52 penetrates through the fourth attachment portion 52 in the disc axis direction.

As illustrated in FIG. 3, the torque receiving portion 60 of the first attachment portion 46 includes a turning-in-side ear accommodating portion 75(a) that is similar to the turning-in-side ear accommodating portion 75(a) of the torque receiving portion 60 of the third attachment portion 51 illustrated in FIG. 6. As illustrated in FIG. 3, the torque receiving portion 60 of the second attachment portion 47 includes a turning-out-side ear accommodating portion 75(b) in a mirror symmetrical form with the turning-in-side ear accommodating portion 75(a) of the torque receiving portion 60 of the first attachment portion 46. The turning-in-side ear accommodating portion 75(a) of the first attachment portion 46 and the turning-out-side ear accommodating portion 75(b) of the second attachment portion 47 face each other in the disc rotation direction and are recessed in directions separated from each other in the disc rotation direction. The turning-in-side ear accommodating portion 75(a) of the first attachment portion 46 and the turning-out-side ear accommodating portion 75(b) of the second attachment portion 47 are located at aligned positions in the disc axis direction and are also located at aligned positions in the disc radial direction. The turning-in-side ear accommodating portion 75(a) of the first attachment portion 46 penetrates through the first attachment portion 46 in the disc axis direction. The turning-out-side ear accommodating portion 75(b) of the second attachment portion 47 penetrates through the second attachment portion 47 in the disc axis direction.

The turning-in-side ear accommodating portion 75(a) of the third attachment portion 51 illustrated in FIG. 6 and the turning-in-side ear accommodating portion 75(a) of the first attachment portion 46 illustrated in FIG. 3 are located aligned positions in the disc radial direction and are also located at aligned positions in the disc rotation direction. The turning-out-side ear accommodating portion 75(b) of the second attachment portion 47 illustrated in FIG. 3 and the turning-out-side ear accommodating portion 75(b) of the fourth attachment portion 52 illustrated in FIG. 6 are located at aligned positions in the disc radial direction and are also located at aligned positions in the disc rotation direction.

In the attachment member 20, the inner-side disposition portion 31 supports the first friction pad 26 with the turning-in-side ear accommodating portion 75(a) provided in the first attachment portion 46 and the turning-out-side ear accommodating portion 75(b) provided in the second attachment portion 47 as illustrated in FIG. 3. Also, in the attachment member 20, the outer-side disposition portion 32 supports the second friction pad 27 with the turning-in-side ear accommodating portion 75(a) provided in the third attachment portion 51 and the turning-out-side ear accommodating portion 75(b) provided in the fourth attachment portion 52 as illustrated in FIG. 6. In the attachment member 20, the turning-in-side fixing portion 42 and the first attachment portion 46 illustrated in FIG. 3 and the turning-in-side coupling portion 33 and the third attachment portion 51 illustrated in FIG. 6 are disposed on the turning-in side at the time of forward moving. In the attachment member 20, the turning-out-side fixing portion 44 and the second attachment portion 47 illustrated in FIG. 3 and the turning-out-side coupling portion 34 and the fourth attachment portion 52 illustrated in FIG. 6 are disposed on the turning-out side at the time of forward moving.

Both the turning-in-side pad spring 24 and the turning-out-side pad spring 25 are provided integrally with the attachment member 20. As illustrated in FIG. 2, the turning-in-side pad spring 24 is attached to the attachment member 20 on the turning-in side at the time of forward moving. At that time, the one turning-in-side pad spring 24 is attached across both the first attachment portion 46 and the third attachment portion 51, both of which are on the turning-in side at the time of forward moving. The turning-out-side pad spring 25 is attached to the attachment member 20 on the turning-out side at the time of forward moving. At that time, the one turning-out-side pad spring 25 is attached to both the second attachment portion 47 and the fourth attachment portion 52, both of which are on the turning-out side at the time of forward moving. In other words, the two pad springs, namely the turning-in-side pad spring 24 and the turning-out-side pad spring 25 are attached to the one attachment member 20.

Both of these turning-in-side pad spring 24 and turning-out-side pad spring 25 are provided between the attachment member 20 and the pair of first friction pad 26 and second friction pad 27 in the disc rotation direction. The turning-in-side pad spring 24 is provided between the first attachment portion 46 and the third attachment portion 51, both of which are on the turning-in side at the time of forward moving of the attachment member 20, and between the pair of first friction pad 26 and second friction pad 27. The turning-out-side pad spring 25 is provided between the second attachment portion 47 and the fourth attachment portion 52, both of which are on the turning-out side at the time of forward moving of the attachment member 20, and between the pair of first friction pad 26 and second friction pad 27. These turning-in-side pad spring 24 and turning-out-side pad spring 25 are attached to the attachment member 20 and elastically support the first friction pad 26 and the second friction pad 27. Moreover, the turning-in-side pad spring 24 and the turning-out-side pad spring 25 guide movement of the first friction pad 26 and the second friction pad 27 in the disc axis direction.

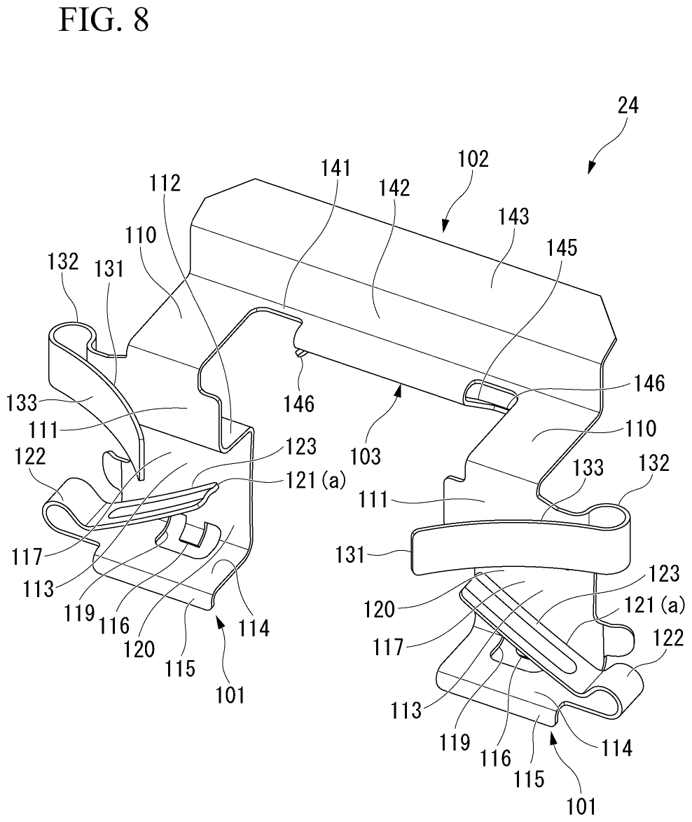

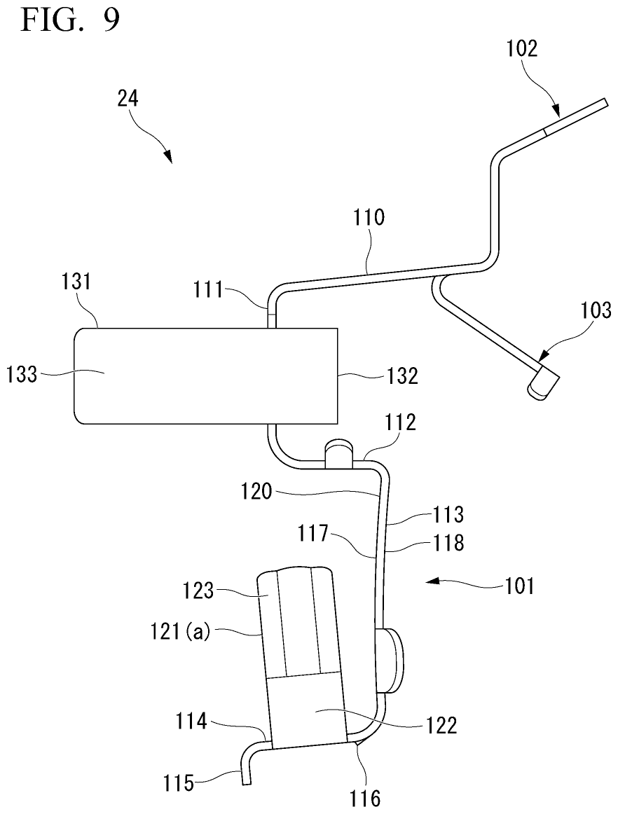

FIGS. 8 and 9 illustrate the turning-in-side pad spring 24 in a natural state before being assembled with the attachment member 20.

As illustrated in FIG. 8, the turning-in-side pad spring 24 has a mirror symmetrical shape. The turning-in-side pad spring 24 is formed through press molding from a single plate material having a specific thickness and made of metal. The turning-in-side pad spring 24 includes a pair of pad support portions 101, a coupling portion 102 that couples the pad support portions 101, and an engagement portion 103 that stretches out from the coupling portion 102. As illustrated in FIG. 2, the pair of pad support portions 101 of the turning-in-side pad spring 24 are disposed on both sides in the disc axis direction with respect to the disc 11. The coupling portion 102 of the turning-in-side pad spring 24 is disposed on the outward side in the disc radial direction with respect to the disc 11. In other words, the disc 11 is disposed between the pair of pad support portions 101 of the turning-in-side pad spring 24.

As illustrated in FIG. 8, the pair of pad support portions 101 of the turning-in-side pad spring 24 have mirror symmetrical shapes. Therefore, one of the pad support portions 101 will be described.

The pad support portion 101 includes an outer end plate portion 110, an outward-side plate portion 111, an outward-side support plate portion 112, a wall plate portion 113, a stretching-out plate portion 114, an inward-side plate portion 115, and an engagement claw 116. All of the outer end plate portion 110, the outward-side plate portion 111, the outward-side support plate portion 112, the stretching-out plate portion 114, the inward-side plate portion 115, and the engagement claw 116 have flat plate shapes.

The outer end plate portion 110 is located at an end portion of the pad support portion 101 on the side of the coupling portion 102.

The outward-side plate portion 111 stretches out on the side opposite to the coupling portion 102 substantially perpendicularly to the outer end plate portion 110 from the outer end plate portion 110 on the side opposite to the coupling portion 102.

The outward-side support plate portion 112 stretches out substantially perpendicularly to the outward-side plate portion 111 from the outward-side plate portion 111 on the side opposite to the outer end plate portion 110. The outward-side support plate portion 112 stretches out on the same side as the outer end plate portion 110 in the thickness direction of the outward-side plate portion 111 from the outward-side plate portion 111.

The wall plate portion 113 stretches out substantially perpendicularly to the outward-side support plate portion 112 from the outward-side support plate portion 112 on the side opposite to the outward-side plate portion 111. The wall plate portion 113 stretches out on the side opposite to the outward-side plate portion 111 from the outward-side support plate portion 112 in the thickness direction of the outward-side support plate portion 112.

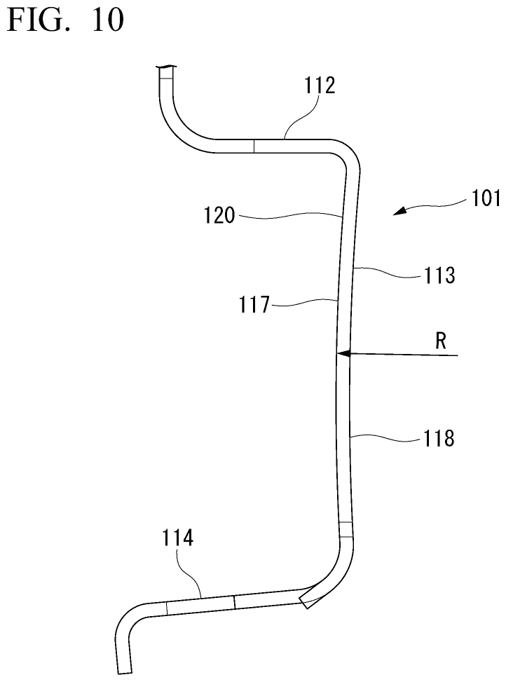

As illustrated in FIG. 9, the wall plate portion 113 has a curved plate shape curved in the thickness direction. The wall plate portion 113 is curved to warp in a projecting shape on the side on which the outward-side support plate portion 112 stretches out, from the wall plate portion 113 in the thickness direction of the wall plate portion 113. In other words, the wall plate portion 113 has a curved surface portion 117 that is curved with a radius R that is greater than 0, on the side of the outward-side support plate portion 112 in the thickness direction of the wall plate portion 113 as illustrated in FIG. 10. Additionally, the wall plate portion 113 also has a curved surface portion 118 that is curved with a radius that is greater than 0, on the side opposite to the outward-side support plate portion 112 in the thickness direction of the wall plate portion 113.

The stretching-out plate portion 114 stretches out substantially perpendicularly to the wall plate portion 113 from the wall plate portion 113 on the side opposite to the outward-side support plate portion 112. The stretching-out plate portion 114 stretches out on the same side as the outward-side support plate portion 112 from the wall plate portion 113 in the thickness direction of the wall plate portion 113. As illustrated in FIG. 8, an intermediate opening 119 is formed in the stretching-out plate portion 114. The intermediate opening 119 penetrates through a predetermined range of the stretching-out plate portion 114 on the side of the wall plate portion 113 in the thickness direction of the stretching-out plate portion 114.

The inward-side plate portion 115 stretches out substantially perpendicularly to the stretching-out plate portion 114 from the stretching-out plate portion 114 on the side opposite to the wall plate portion 113. The inward-side plate portion 115 stretches out on the side opposite to the wall plate portion 113 from the stretching-out plate portion 114 in the thickness direction of the stretching-out plate portion 114.

The engagement claw 116 projects from the wall plate portion 113 through the intermediate opening 119 and up to the side opposite to the outward-side support plate portion 112 as compared with the stretching-out plate portion 114. The engagement claw 116 forms an obtuse angle with respect to the wall plate portion 113 and projects from the wall plate portion 113. The engagement claw 116 projects on the same side as the stretching-out plate portion 114 in the thickness direction of the wall plate portion 113.

A boundary line between the outer end plate portion 110 and the outward-side plate portion 111, a boundary line between the outward-side plate portion 111 and the outward-side support plate portion 112, a boundary line between the outward-side support plate portion 112 and the wall plate portion 113, a boundary line between the wall plate portion 113 and the stretching-out plate portion 114, and a boundary line between the stretching-out plate portion 114 and the inward-side plate portion 115 are parallel with each other.

The wall plate portion 113 is curved with an axis that is parallel with these boundary lines located at a center. The outward-side plate portion 111 and the wall plate portion 113 spread to be substantially parallel with each other. As illustrated in FIG. 9, the stretching-out plate portion 114 spreads to be slightly inclined with respect to the outward-side support plate portion 112 so as to be further separated from the outward-side support plate portion 112 as it is separated from the wall plate portion 113.

The outer end plate portion 110, the outward-side support plate portion 112, and the stretching-out plate portion 114 spread to be substantially parallel with each other. The outward-side plate portion 111, the wall plate portion 113, and the inward-side plate portion 115 spread to be substantially parallel with each other.

The outward-side support plate portion 112, the wall plate portion 113, and the stretching-out plate portion 114 that are continuous with each other are coupled to form a recessed shape with respect to the outward-side plate portion 111 and the inward-side plate portion 115 and constitute a guide recessed portion 120 as a whole.

The pad support portion 101 includes a turning-in-side pushing-up spring 121(a). The turning-in-side pushing-up spring 121(a) stretches out on a side opposite to the other pad support portion 101 from an end edge portion of the stretching-out plate portion 114 of the pad support portion 101 on the side opposite to the other pad support portion 101, is then folded back on the side of the outward-side support plate portion 112 in the thickness direction of the stretching-out plate portion 114, and stretches out on the side of the other pad support portion 101.

The turning-in-side pushing-up spring 121(a) has a curved plate portion 122 and an inward-side support plate portion 123. The curved plate portion 122 is curved in a substantially cylindrical shape. In the one pad support portion 101, the curved plate portion 122 stretches out from the end edge portion of the stretching-out plate portion 114 on the side opposite to the other pad support portion 101. In the one pad support portion 101, the curved plate portion 122 stretches out from the stretching-out plate portion 114 in a direction away from the other pad support portion 101 while approaching the outward-side support plate portion 112 in the thickness direction of the stretching-out plate portion 114. Thereafter, the curved plate portion 122 stretches out in a direction in which it approaches the other pad support portion 101 while approaching the outward-side support plate portion 112 in the thickness direction of the stretching-out plate portion 114. Thereafter, the curved plate portion 122 stretches out in a direction in which it approaches the other pad support portion 101 while being separated from the outward-side support plate portion 112 in the thickness direction of the stretching-out plate portion 114.

In the one pad support portion 101, the inward-side support plate portion 123 stretches out linearly in the direction of the other pad support portion 101 from an end edge portion of the curved plate portion 122 on the side opposite to an end edge portion on the side on which it is continuous with the stretching-out plate portion 114. In the one pad support portion 101, the inward-side support plate portion 123 stretches out from the curved plate portion 122 so as to be separated from the stretching-out plate portion 114 in the thickness direction of the stretching-out plate portion 114 toward the side of the other pad support portion 101. The turning-in-side pushing-up spring 121 (a) is elastically deformed mainly at the curved plate portion 122.

The pad support portion 101 includes a turning-in-side side pushing spring 131. The turning-in-side side pushing spring 131 stretches out on the side opposite to the other pad support portion 101 from an end edge portion of the outward-side plate portion 111 of the pad support portion 101 on the side opposite to the other pad support portion 101, is then folded back on the side opposite to the wall plate portion 113 in the thickness direction of the outward-side plate portion 111, and stretches out on the side of the other pad support portion 101.

The turning-in-side side pushing spring 131 includes a curved plate portion 132 and a support plate portion 133. The curved plate portion 132 is curved into a substantially cylindrical shape. In the one pad support portion 101, the curved plate portion 132 stretches out from the end edge portion of the outward-side plate portion 111 on the side opposite to the other pad support portion 101. In the one pad support portion 101, the curved plate portion 132 stretches out in a direction in which it is separated from the other pad support portion 101 while stretching out on the same side as the outward-side support plate portion 112 in the thickness direction of the outward-side plate portion 111 from the outward-side plate portion 111. Thereafter, the curved plate portion 132 stretches out in the direction in which it is separated from the other pad support portion 101 while stretching out in a direction opposite to the outward-side support plate portion 112 in the thickness direction of the outward-side plate portion 111. Thereafter, the curved plate portion 132 stretches out in a direction in which it approaches the other pad support portion 101 while stretching out in the direction opposite to the outward-side support plate portion 112 in the thickness direction of the outward-side plate portion 111.

In the one pad support portion 101, the support plate portion 133 stretches out in the direction of the other pad support portion 101 from an end edge portion of the curved plate portion 132 on the side opposite to an end edge portion on a side on which it is continuous with the outward-side plate portion 111. In the one pad support portion 101, the support plate portion 133 stretches out from the curved plate portion 132 so as to be separated from the outward-side plate portion 111 in the thickness direction of the outward-side plate portion 111 toward the other pad support portion 101. In the one pad support portion 101, the support plate portion 133 is curved in an arc shape around an axis located on the side opposite to the outward-side plate portion 111 in the thickness direction of the support plate portion 133, which is also an axis extending perpendicularly to the outward-side support plate portion 112.

The turning-in-side pad spring 24 includes the pair of pad support portions 101 described above in a mirror symmetrical form.

The coupling portion 102 includes a base end coupling plate portion 141, an intermediate coupling plate portion 142, and a distal end plate portion 143. All of the base end coupling plate portion 141, the intermediate coupling plate portion 142, and the distal end plate portion 143 have flat plate shapes.

The base end coupling plate portion 141 is disposed in the same plane as the outer end plate portions 110 of the pair of pad support portions 101 and couples them. The base end coupling plate portion 141 couples end edge portions of the pair of outer end plate portions 110 on the sides opposite to the outward-side plate portions 111.

The intermediate coupling plate portion 142 stretches out on the side opposite to the pair of outward-side plate portions 111 in the thickness direction of the base end coupling plate portion 141 from an end edge portion of the base end coupling plate portion 141 on the side opposite to the pair of outer end plate portions 110.

The distal end plate portion 143 stretches out on the side opposite to the base end coupling plate portion 141 in the thickness direction of the intermediate coupling plate portion 142 from an end edge portion of the intermediate coupling plate portion 142 on the side opposite to the base end coupling plate portion 141.

The distal end plate portion 143 stretches out such that it is further separated from the base end coupling plate portion 141 in the thickness direction of the base end coupling plate portion 141 as it is separated from the intermediate coupling plate portion 142.

The engagement portion 103 includes a substrate portion 145 and a pair of engagement projecting portions 146.

The substrate portion 135 stretches out in a direction in which it is separated from the base end coupling plate portion 141 in the thickness direction of the intermediate coupling plate portion 142 from a position between the pair of outer end plate portions 110 at the base end coupling plate portion 141 and is then folded back on the side opposite to the intermediate coupling plate portion 142 in the thickness direction of the base end coupling plate portion 141.

Thereafter, the substrate portion 135 stretches out to be separated from the pair of outward-side plate portions 111 in the thickness direction of the intermediate coupling plate portion 142 and to be separated from the intermediate coupling plate portion 142 in the thickness direction of the base end coupling plate portion 141.

The pair of engagement projecting portions 146 are provided at an end portion of the substrate portion 145 on the side opposite to the base end coupling plate portion 141. One of the engagement projecting portions 146 projects from an end edge portion of the substrate portion 145 on the side of one of the outer end plate portion 110. The other engagement projecting portion 146 projects from an end edge portion of the substrate portion 145 on the side of the other outer end plate portion 110. The pair of engagement projecting portions 146 projects on the side opposite to the base end coupling plate portion 141 in the thickness direction of the substrate portion 145. The pair of engagement projecting portions 146 have a gap therebetween increasing as they are separated from the substrate portion 145.

A boundary line between the base end coupling plate portion 141 and the intermediate coupling plate portion 142, a boundary line between the intermediate coupling plate portion 142 and the distal end plate portion 143, and a boundary line between the base end coupling plate portion 141 and the substrate portion 145 are parallel with the boundary line between the outer end plate portion 110 and the outward-side plate portion 111.

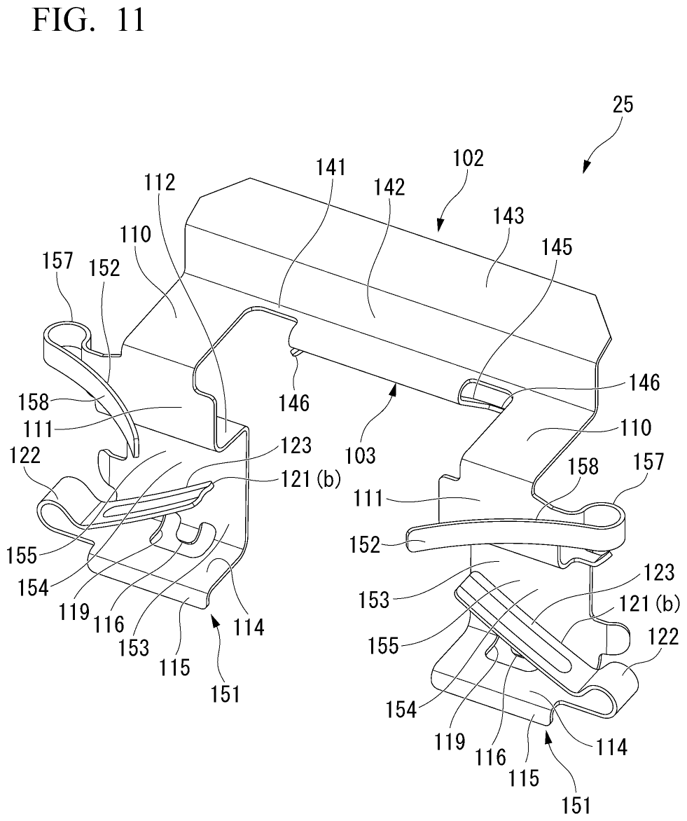

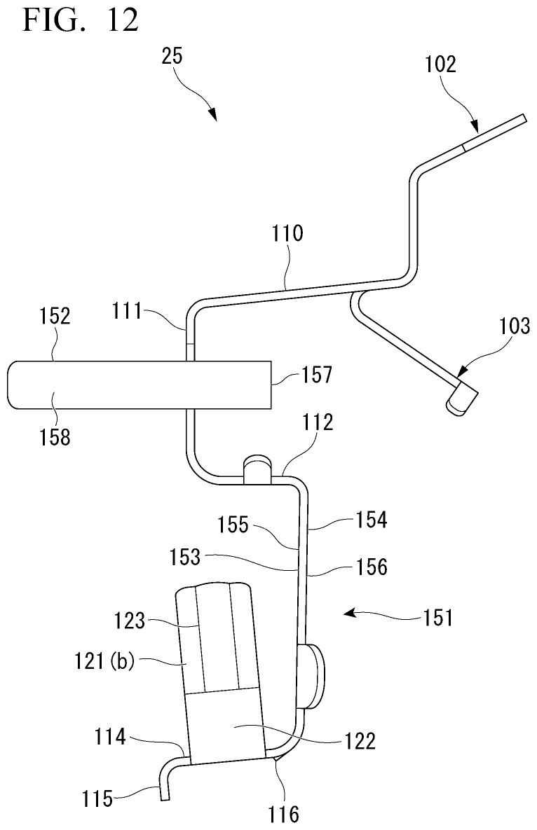

FIGS. 11 and 12 illustrate the turning-out-side pad spring 25 in a natural state before being assembled with the attachment member 20. The turning-out-side pad spring 25 is partially different from the turning-in-side pad spring 24 illustrated in FIGS. 8 and 9.

The turning-out-side pad spring 25 has a mirror symmetrical shape. The turning-out-side pad spring 25 is formed through press molding from a single plate member having a specific thickness and made of metal. The turning-out-side pad spring 25 includes a pair of pad support portions 151 that are partially different from the pair of pad support portions 101, instead of the pair of pad support portions 101. Moreover, the turning-out-side pad spring 25 includes a pair of turning-out-side side pushing springs 152 that are partially different from the pair of turning-in-side side pushing springs 131, instead of the pair of turning-in-side side pushing springs 131.

As illustrated in FIG. 12, the pad support portion 151 includes a guide recessed portion 153 that is partially different from the guide recessed portion 120, instead of the guide recessed portion 120. The guide recessed portion 153 includes a wall plate portion 154 that is different from the wall plate portion 113, instead of the wall plate portion 113. The wall plate portion 154 has a flat plate shape spreading substantially perpendicularly to the outward-side support plate portion 112 and the stretching-out plate portion 114. In other words, the wall plate portion 154 includes a flat planar portion 155 on the side of the outward-side support plate portion 112 in the thickness direction of the wall plate portion 154. Also, the wall plate portion 154 also includes a flat planar portion 156 on the side opposite to the outward-side support plate portion 112 in the thickness direction of the wall plate portion 154. The pad support portion 151 includes a turning-out-side pushing-up spring 121(b) similar to the turning-in-side pushing-up spring 121(a).

The width of the turning-out-side side pushing spring 152 in the direction perpendicularly intersecting the outward-side support plate portion 112 is smaller than the width of the turning-in-side side pushing spring 131 in the direction perpendicularly intersecting the outward-side support plate portion 112. The turning-out-side side pushing spring 152 includes a curved plate portion 157 and a support plate portion 158.

The curved plate portion 157 is curved similarly to the curved plate portion 132. The width of the curved plate portion 157 in the direction perpendicularly intersecting the outward-side support plate portion 112 is smaller than the width of the curved plate portion 132 in the direction perpendicularly intersecting the outward-side support plate portion 112. In one pad support portion 151, the curved plate portion 157 stretches out from an end edge portion of the outward-side plate portion 111 on the side opposite to the other pad support portion 151. In the one pad support portion 151, the curved plate portion 157 stretches out in a direction in which it is separated from the other pad support portion 151 while stretching out on the same side as the outward-side support plate portion 112 in the thickness direction of the outward-side plate portion 111 from the outward-side plate portion 111. Thereafter, the curved plate portion 157 stretches out in the direction in which it is separated from the other pad support portion 151 while stretching out in the direction opposite to the outward-side support plate portion 112 in the thickness direction of the outward-side plate portion 111. Thereafter, the curved plate portion 157 stretches out in a direction in which it approaches the other pad support portion 151 while stretching out in a direction opposite to the outward-side support plate portion 112 in the thickness direction of the outward-side plate portion 111.

The support plate portion 158 stretches out from the curved plate portion 157 similarly to the support plate portion 133 with respect to the curved plate portion 132. The width of the support plate portion 158 in the direction perpendicularly intersecting the outward-side support plate portion 112 is smaller than the width of the support plate portion 133 in the direction perpendicularly intersecting the outward-side support plate portion 112. In the one pad support portion 151, the support plate portion 158 stretches out in the direction of the other pad support portion 151 from an end edge portion of the curved plate portion 157 on the side opposite to the end edge portion on the side on which it is continuous with the outward-side plate portion 111. In the one pad support portion 151, the support plate portion 158 stretches out from the curved plate portion 157 such that it is further separated from the outward-side plate portion 111 in the thickness direction of the outward-side plate portion 111 toward the side of the other pad support portion 151. In the one pad support portion 151, the support plate portion 158 is curved in an arc shape around an axis on the side opposite to the outward-side plate portion 111 in the thickness direction of the support plate portion 158, which is an axis extending perpendicularly to the outward-side support plate portion 112.

The turning-out-side side pushing spring 152 and the turning-in-side side pushing spring 131 similarly have curved shapes, and the width of the turning-out-side side pushing spring 152 in the direction perpendicularly intersecting the stretching-out direction is smaller than the width of the turning-in-side side pushing spring 131 in the direction perpendicularly intersecting the stretching-out direction. Therefore, the turning-out-side side pushing spring 152 has a smaller spring constant than the turning-in-side side pushing spring 131.

The other configurations of the turning-out-side pad spring 25 are similar to those of the turning-in-side pad spring 24 illustrated in FIGS. 8 and 9.

As illustrated in FIG. 2, the turning-in-side pad spring 24 is attached to the first attachment portion 46 and the third attachment portion 51, both of which are on the turning-in side at the time of forward moving of the attachment member 20. At that time, the turning-in-side pad spring 24 is brought into a state where the coupling portion 102 is disposed on the further outward side in the disc radial direction than the pad support portion 101. Also, at that time, the guide recessed portion 120 of the one pad support portion 101 is fitted to the turning-in-side ear accommodating portion 75(a) of the third attachment portion 51 as illustrated in FIG. 6, and the guide recessed portion 120 of the other pad support portion 101 is fitted into the turning-in-side ear accommodating portion 75(a) of the first attachment portion 46, in the turning-in-side pad spring 24 as illustrated in FIG. 3. In this manner, the turning-in-side pad spring 24 is provided with movement in the disc radial direction and in the turning-in side at the time of forward moving restricted by the attachment member 20. Also, at that time, one of the engagement projecting portions 146 of the engagement portion 103 abuts a surface of the first attachment portion 46 on the side of the third attachment portion 51, and the other engagement projecting portion 146 abuts a surface of the third attachment portion 51 on the side of the first attachment portion 46, as illustrated in FIG. 4 in the turning-in-side pad spring 24. In this manner, the turning-in-side pad spring 24 is provided with movement in the disc axis direction restricted by the attachment member 20. In other words, the turning-in-side pad spring 24 is attached while being positioned in the disc radial direction, the disc rotation direction, and the disc axis direction with respect to the attachment member 20.

In this manner, the turning-in-side pad spring 24 is brought into a state where the pair of pad support portions 101 are disposed on both sides of the disc 11 in the disc axis direction as illustrated in FIG. 2. Also, in this state, the turning-in-side pad spring 24 is brought into a state where the guide recessed portion 120 of the one pad support portion 101 and the turning-in-side pushing-up spring 121(a) illustrated in FIG. 3 are disposed inside the turning-in-side ear accommodating portion 75(a) of the first attachment portion 46 of the attachment member 20 while the guide recessed portion 120 of the other pad support portion 101 and the turning-in-side pushing-up spring 121(a) illustrated in FIG. 6 are disposed inside the turning-in-side ear accommodating portion 75(a) of the third attachment portion 51 of the attachment member 20.

In this manner, the turning-in-side pad spring 24 provided on the turning-in side at the time of forward moving has a shape in which the pair of guide recessed portions 120 that are fitted to the pair of turning-in-side ear accommodating portions 75(a) are recessed outward in the disc rotation direction in an attached state where the turning-in-side pad spring 24 is attached to the first attachment portion 46 and the third attachment portion 51.

In the turning-in-side pad spring 24 in the attached state in which it is attached to the attachment member 20, the pad support portion 101 on the outer side illustrated in FIG. 6 is engaged with a torque receiving portion 60 of the third attachment portion 51, and the pad support portion 101 on the inner side illustrated in FIG. 3 is engaged with a torque receiving portion 60 of the first attachment portion 46. In the turning-in-side pad spring 24, the engagement state between the pad support portion 101 on the outer side and the torque receiving portion 60 of the third attachment portion 51 illustrated in FIG. 6 and the engagement state between the pad support portion 101 on the inner side and the torque receiving portion 60 of the first attachment portion 46 illustrated in FIG. 3 are similar to each other. Therefore, the engagement state of the turning-in-side pad spring 24 between the pad support portion 101 on the outer side and the third attachment portion 51 will be described mainly on the basis of FIG. 7 here.

In the pad support portion 101 of the turning-in-side pad spring 24 on the outer side, the wall plate portion 113 of the guide recessed portion 120 is disposed on the outward side of the guide recessed portion 120 in the disc rotation direction.

At that time, the wall plate portion 113 of the guide recessed portion 120 faces the third surface portion 63 of the turning-in-side ear accommodating portion 75(a) on the furthest side in the recessed direction and abuts the third surface portion 63. In this state, the wall plate portion 113 spreads substantially in parallel with the reference plane in the radial direction similarly to the third surface portion 63. The wall plate portion 113 is curved as described above, the outer end portion in the disc radial direction abuts the third surface portion 63, and the intermediate portion in the disc radial direction is separated from the third surface portion 63 in the disc rotation direction. The inner end portion of the wall plate portion 113 in the disc radial direction has a slight clearance that is smaller than the intermediate portion in the disc radial direction between itself and the third surface portion 63.

Also, the outward-side support plate portion 112 of the guide recessed portion 120 is disposed on the outward side of the guide recessed portion 120 in the disc radial direction in the pad support portion 101 of the turning-in-side pad spring 24 on the outer side. At that time, the outward-side support plate portion 112 of the guide recessed portion 120 faces the fourth surface portion 64 of the turning-in-side ear accommodating portion 75(a) on the outward side in the disc radial direction and is in surface contact with the fourth surface portion 64. At this time, the outward-side support plate portion 112 spreads perpendicularly to the reference line in the radial direction along the disc axis similarly to the fourth surface portion 64.

Additionally, the stretching-out plate portion 114 of the guide recessed portion 120 of the pad support portion 101 of the turning-in-side pad spring 24 on the outer side is disposed on the inward side of the guide recessed portion 120 in the disc radial direction. At that time, the stretching-out plate portion 114 of the guide recessed portion 120 faces the second surface portion 62 of the turning-in-side ear accommodating portion 75(a) on the inward side in the disc radial direction and is in surface contact with the second surface portion 62. In this state, the stretching-out plate portion 114 spreads substantially perpendicularly to the reference line in the radial direction along the disc axis direction similarly to the second surface portion 62.

In addition, the engagement claw 116 illustrated in FIG. 8 in the pad support portion 101 of the turning-in-side pad spring 24 on the outer side is disposed on the inward side of the guide recessed portion 120 in the disc radial direction. In this state, the engagement claw 116 abuts the second surface portion 62 of the turning-in-side ear accommodating portion 75(a) illustrated in FIG. 7 and is elastically deformed outward in the disc radial direction.

Moreover, the inward-side plate portion 115 of the pad support portion 101 of the turning-in-side pad spring 24 on the outer side stretches out on the inward side in the disc radial direction from the stretching-out plate portion 114 and faces the first surface portion 61 in the disc rotation direction.

Also, the outward-side plate portion 111 of the pad support portion 101 of the turning-in-side pad spring 24 on the outer side stretches out on the outward side in the disc radial direction from the outward-side support plate portion 112 and faces the fifth surface portion 65 in the disc rotation direction.

As described above, the guide recessed portion 120 of the pad support portion 101 of the turning-in-side pad spring 24 on the outer side is fitted to the turning-in-side ear accommodating portion 75(a). At that time, the pad support portion 101 abuts the turning-in-side ear accommodating portion 75(a) at the outward-side support plate portion 112, the wall plate portion 113, the stretching-out plate portion 114, and the engagement claw 116.

In the pad support portion 101 of the turning-in-side pad spring 24 on the outer side, the outward-side support plate portion 112 and the stretching-out plate portion 114 spread inward in the disc rotation direction from an end edge portion of the wall plate portion 113 on the outward side in the disc radial direction and from an end edge portion of the wall plate portion 113 on the inward side in the disc radial direction, respectively. All of the outward-side support plate portion 112, the wall plate portion 113, and the stretching-out plate portion 114 spread in the disc axis direction.

Also, the curved plate portion 122 of the turning-in-side pushing-up spring 121 (a) of the pad support portion 101 of the turning-in-side pad spring 24 on the outer side is provided in the stretching-out plate portion 114 on the side opposite to the disc 11 in the disc axis direction. The curved plate portion 122 stretches out on the side opposite to the disc 11 from the stretching-out plate portion 114 and is then folded back on the outward side in the disc radial direction. Then, the inward-side support plate portion 123 illustrated in FIG. 8 of the turning-in-side pushing-up spring 121(a) stretches out so as to approach the disc 11 in the disc axis direction from the curved plate portion 122.

Moreover, curved plate portion 132 of the turning-in-side side pushing spring 131 of the pad support portion 101 of the turning-in-side pad spring 24 on the outer side is provided at the outward-side plate portion 111 on the side opposite to the disc 11 in the disc axis direction. The curved plate portion 132 stretches out on the side opposite to the disc 11 from the outward-side plate portion 111 and is then folded back on the inward side in the disc rotation direction. Then, the support plate portion 133 illustrated in FIG. 8 of the turning-in-side side pushing spring 131 stretches out so as to approach the disc 11 in the disc axis direction from the curved plate portion 132. At that time, the support plate portion 133 of the turning-in-side side pushing spring 131 stretches out to be located further inward in the disc rotation direction as it approaches the disc 11 in the disc axis direction.

As illustrated in FIG. 7, the wall plate portion 113 of the pad support portion 101 of the turning-in-side pad spring 24 on the outer side covers the third surface portion 63 of the torque receiving portion 60 of the third attachment portion 51.

The wall plate portion 113 of the pad support portion 101 of the turning-in-side pad spring 24 on the outer side is offset in the disc radial direction with respect to the turning-in-side side pushing spring 131. Specifically, the wall plate portion 113 is offset on the inward side in the disc radial direction with respect to the turning-in-side side pushing spring 131.

In the turning-in-side pad spring 24 in an attached state in which it is attached to the attachment member 20, the pad support portion 101 on the inner side as illustrated in FIG. 3 is engaged with the torque receiving portion 60 of the first attachment portion 46 similarly to the engagement of the pad support portion 101 on the outer side as illustrated in FIG. 7 with the torque receiving portion 60 of the third attachment portion 51.

In the turning-in-side pad spring 24 in the attached state in which it is attached to the attachment member 20, the intermediate coupling plate portion 142 and the distal end plate portion 143 of the coupling portion 102 stretches out on the outward side in the disc radial direction from an end edge portion of the base end coupling plate portion 141 as illustrated in FIG. 8 on the side opposite to the pair of outer end plate portions 110. In the attached state, the intermediate coupling plate portion 142 faces the seventh surface portion 67 in the disc rotation direction as illustrated in FIG. 7.

As illustrated in FIG. 2, the turning-out-side pad spring 25 is attached to the second attachment portion 47 and the fourth attachment portion 52 of the attachment member 20, both of which are on the turning-out side at the time of forward moving, similarly to the attachment of the turning-in-side pad spring 24 to the first attachment portion 46 and the third attachment portion 51.

In the turning-out-side pad spring 25 in the attached state in which it is attached to the attachment member 20, the pad support portion 151 on the outer side as illustrated in FIG. 6 is engaged with the torque receiving portion 60 of the fourth attachment portion 52. Moreover, in the turning-out-side pad spring 25 in an attached state, the pad support portion 151 on the inner side as illustrated in FIG. 3 is engaged with the torque receiving portion 60 of the second attachment portion 47.

However, the flat plate-shaped wall plate portion 154 of the turning-out-side pad spring 25 on the outer side abuts the third surface portion 63 of the fourth attachment portion 52 through a surface contact as illustrated in FIG. 6 at that time. Furthermore, the flat plate-shaped wall plate portion 154 on the inner side abuts the third surface portion 63 of the second attachment portion 47 through a surface contact as illustrated in FIG. 3 at that time.

The curved plate portion 157 of the turning-out-side side pushing spring 152 of the pad support portion 151 of the turning-out-side pad spring 25 on the outer side as illustrated in FIG. 11 is provided at the outward-side plate portion 111 on the side opposite to the disc 11 in the disc axis direction. The curved plate portion 157 stretches out on the side opposite to the disc 11 from the outward-side plate portion 111 and is then folded back on the inward side in the disc rotation direction. Then, the support plate portion 158 of the turning-out-side side pushing spring 152 stretches out to approach the disc 11 in the disc axis direction from the curved plate portion 157. At that time, the support plate portion 158 of the turning-out-side side pushing spring 152 stretches out to be located further inward in the disc rotation direction as it approaches the disc 11 in the disc axis direction.

The wall plate portion 154 of the pad support portion 151 of the turning-out-side pad spring 25 on the outer side is offset in the disc radial direction with respect to the turning-out-side side pushing spring 152, specifically the wall plate portion 154 is offset on the inward side in the disc radial direction with respect to the turning-out-side side pushing spring 152.

The pad support portion 151 on the inner side as illustrated in FIG. 3 in the turning-out-side pad spring 25 in the attached state in which it is attached to the attachment member 20 is engaged with the torque receiving portion 60 of the second attachment portion 47 similarly to the engagement of the pad support portion 151 on the outer side as illustrated in FIG. 6 with the torque receiving portion 60 of the fourth attachment portion 52.

As described above, the turning-in-side pad spring 24 and the turning-out-side pad spring 25 are attached to the attachment member 20 while facing each other in the disc rotation direction in a state where they are separated from each other in the disc rotation direction.

The first friction pad 26 illustrated in FIG. 3 and the second friction pad 27 illustrated in FIG. 6 are engaged with the turning-in-side pad spring 24 and the turning-out-side pad spring 25 attached to the attachment member 20. As illustrated in FIG. 3, the first friction pad 26 is supported by the first attachment portion 46 and the second attachment portion 47 of the attachment member 20 via the turning-in-side pad spring 24 and the turning-out-side pad spring 25. As illustrated in FIG. 6, the second friction pad 27 is supported by the third attachment portion 51 and the fourth attachment portion 52 of the attachment member 20 via the turning-in-side pad spring 24 and the turning-out-side pad spring 25. The longitudinal directions of both the first friction pad 26 and the second friction pad 27 are aligned in the disc rotation direction.

The first friction pad 26 on the inner side as illustrated in FIG. 3 and the second friction pad 27 on the outer side as illustrated in FIG. 6 are components with substantially the same shapes.

As illustrated in FIG. 2, the first friction pad 26 has a rear plate 171. The second friction pad 27 has a rear plate 172. Each of the first friction pad 26 and the second friction pad 27 has a lining 173 with a common shape. The lining 173 is attached to each of the rear plates 171 and 172 on one surface side in the thickness direction. For the first friction pad 26, the longitudinal direction of the rear plate 171 is the longitudinal direction thereof. For the second friction pad 27, the longitudinal direction of the rear plate 172 is the longitudinal direction thereof. In the first friction pad 26, the rear plate 171 is supported by the attachment member 20 via the turning-in-side pad spring 24 and the turning-out side pad spring 25 in a state where a distal end surface 174 of the lining 173 on the side opposite to the rear plate 172 is caused to face the disc 11. In the second friction pad 27, the rear plate 172 is supported by the attachment member 20 via the turning-in-side pad spring 24 and the turning-out-side pad spring 25 in a state where the distal end surface 174 of the lining 173 on the side opposite to the rear plate 172 is caused to face the disc 11.

The rear plate 171 of the first friction pad 26 has a mirror symmetrical shape.

As illustrated in FIG. 3, the rear plate 171 includes a main body portion 175 and a pair of turning-in-side ear portion 176(a) and turning-out-side ear portion 176(b). The main body portion 175 is provided at the center of the rear plate 171 in the longitudinal direction. The main body portion 175 is long in the longitudinal direction of the rear plate 171. The lining 173 is attached to the main body portion 175 as illustrated in FIG. 2. The lining 173 also has a mirror symmetrical shape.

As illustrated in FIG. 3, a pair of attachment holes 181 penetrating through the main body portion 175 in the thickness direction are formed at the main body portion 175 on both side in the longitudinal direction thereof. The pair of attachment holes 181 are formed at positions where the lining 173 is not attached in the main body portion 175. An abrasion sensor 183 is attached to predetermined one of the pair of attachment holes 181 with a rivet 182. The abrasion sensor 183 is attached to a surface on the side opposite to the lining 173 in the thickness direction of the main body portion 175 and stretches out on the side of the lining 173 as compared with the surface of the main body portion 175 on the side of the lining 173 in the thickness direction through the outward side of the main body portion 175. The main body portion 175 includes a pair of turning-in-side friction pad portion 184(a) and turning-out-side friction pad portion 184(b) at both end portions in the longitudinal direction. The pair of turning-in-side friction pad portion 184(a) and turning-out-side friction pad portion 184(b) are parallel with each other.

In the rear plate 171, the pair of turning-in-side ear portion 176(a) and turning-out-side ear portion 176(b) also have mirror symmetrical shapes. The one turning-in-side ear portion 176(a) is provided at one end portion of the rear plate 171 in the longitudinal direction. The other turning-out-side ear portion 176(b) is provided at the other end portion of the rear plate 171 in the longitudinal direction. The turning-in-side ear portion 176(a) projects on the outward side in the longitudinal direction of the main body portion 175 from the turning-in-side friction pad portion 184(a) on the side of the one end of the main body portion 175 in the longitudinal direction. The turning-out-side ear portion 176(b) projects on the outward side in the longitudinal direction of the main body portion 175 from the turning-out-side friction pad portion 184(b) on the side of the other end of the main body portion 175 in the longitudinal direction. Therefore, the pair of turning-in-side ear portion 176(a) and turning-out-side ear portion 176(b) project in mutually opposite directions in the longitudinal direction of the main body portion 175 from both end portions of the main body portion 175 in the longitudinal direction.

The rear plate 172 of the second friction pad 27 illustrated in FIG. 6 includes a main body portion 185 that is partially different from the main body portion 175. The main body portion 185 is different from the main body portion 175 in that the pair of attachment holes 181 are not formed therein.

The rear plate 172 includes a pair of turning-in-side ear portion 176(a) and turning-out-side ear portion 176(b) that are similar to those of the rear plate 171.

As illustrated in FIG. 3, one of the pair of turning-in-side ear portion 176(a) and turning-out-side ear portion 176(b) of the first friction pad 26 serves as the turning-in-side ear portion 176(a) on the turning-in side at the time of forward moving, and the other one serves as the turning-out-side ear portion 176(b) on the turning-out side at the time of forward moving. As illustrated in FIG. 6, one of the pair of turning-in-side ear portion 176(a) and turning-out-side ear portion 176(b) of the second friction pad 27 serves as the turning-in-side ear portion 176(a) on the turning-in side at the time of forward moving, and the other one serves as the turning-out-side ear portion 176(b) on the turning-out side at the time of forward moving. Therefore, each of the pair of first friction pad 26 and second friction pad 27 includes the turning-in-side ear portion 176(a) on the turning-in side at the time of forward moving and the turning-out-side ear portion 176(b) on the turning-out side at the time of forward moving.

The turning-in-side ear portion 176(a) of the first friction pad 26 on the turning-in side at the time of forward moving and the turning-out-side ear portion 176(b) of the first friction pad 26 on the turning-out side at the time of forward moving as illustrated in FIG. 3 and the turning-in-side ear portion 176(a) of the second friction pad 27 on the turning-in side at the time of forward moving and the turning-out-side ear portion 176(b) of the second friction pad 27 on the turning-out side at the time of forward moving as illustrated in FIG. 6 have the same shapes. Therefore, the turning-in-side ear portion 176(a) of the second friction pad 27 on the turning-in side at the time of forward moving among these will be described as an example mainly with reference to FIG. 7.

The turning-in-side ear portion 176(a) of the second friction pad 27 includes an inward-side surface portion 191, an outward-side surface portion 192, and a distal end surface portion 193. All of the inward-side surface portion 191, the outward-side surface portion 192, and the distal end surface portion 193 have planar shapes, and all of them spread in the thickness direction of the rear plate 171.

Both the inward-side surface portion 191 and the outward-side surface portion 192 stretch out in the longitudinal direction of the rear plate 172 from the main body portion 185. The outward-side surface portion 192 stretches out from the side of the one end of the friction pad portion 184 of the main body portion 185. The outward-side surface portion 192 is parallel with the inward-side surface portion 191 and faces the side opposite to the inward-side surface portion 191. The distal end surface portion 193 is located at an end portion on the side opposite to the main body portion 185 in the longitudinal direction of the rear plate 171. The distal end surface portion 193 spreads perpendicularly to the inward-side surface portion 191 and the outward-side surface portion 192. An attachment hole 194 penetrating through the turning-in-side ear portion 176(a) in the thickness direction is formed in the turning-in-side ear portion 176(a). A turning-in-side return spring 196(a) is attached to the attachment hole 194 with a rivet 195 as illustrated in FIG. 6.

As illustrated in FIG. 3, the turning-in-side return spring 196(a) and a turning-out-side return spring 196(b) are fixed to the first friction pad 26 at a position of the turning-in-side ear portion 176(a) on one side of the rear surface 161 in the disc rotation direction on the side opposite to the lining 173 in the thickness direction of the rear plate 171 and at a position of the turning-out-side ear portion 176(b) on the other side of the rear surface 161 in the disc rotation direction, respectively. In other words, the pair of turning-in-side return spring 196(a) and turning-out-side return spring 196(b) are fixed to the rear surface 161 of the first friction pad 26 on the side opposite to the distal end surface 174 that abuts the disc 11.

As illustrated in FIG. 6, the turning-in-side return spring 196(a) and the turning-out-side return spring 196(b) are fixed to the second friction pad 27 at a position of the turning-in-side ear portion 176(a) on one side of the rear surface 162 in the disc rotation direction on the side opposite to the lining 173 in the thickness direction of the rear plate 172 and at a position of the turning-out-side ear portion 176(b) on the other side of the rear surface 161 in the disc rotation direction, respectively. In other words, the pair of turning-in-side return spring 196(a) and turning-out-side return spring 196(b) are fixed to the rear surface 161 of the second friction pad 27 on the side opposite to the distal end surface 174 that abuts the disc 11.

The turning-in-side ear portion 176(a) of the second friction pad 27 is engaged with the pad support portion 101 of the turning-in-side pad spring 24 on the outer side on which it is attached to the third attachment portion 51. The turning-out-side ear portion 176(b) of the second friction pad 27 is engaged with the pad support portion 151 of the turning-out-side pad spring 25 on the outer side on which it is attached to the fourth attachment portion 52. In this manner, the longitudinal direction of the second friction pad 27 is aligned with the disc rotation direction.

Here, when the second friction pad 27 is attached to the attachment member 20 via the turning-in-side pad spring 24 and the turning-out-side pad spring 25, the turning-in-side ear portion 176(a) of the second friction pad 27 abuts, on its inward-side surface portion 191 on the inward side in the disc radial direction, the inward-side support plate portion 123 illustrated in FIG. 8 of the turning-in-side pushing-up spring 121(a) of the turning-in-side pad spring 24 on the outer side, and is inserted into the guide recessed portion 120 of the turning-in-side pad spring 24 on the outer side illustrated in FIG. 6 with the inward-side support plate portion 123 elastically deformed inward in the disc radial direction so as to cause the inward-side support plate portion 123 to approach the stretching-out plate portion 114. At that time, the main body portion 185 of the second friction pad 27 abuts, on its turning-in-side friction pad portion 184(a) out of the pair of turning-in-side friction pad portion 184(a) and turning-out-side friction pad portion 184(b) on the turning-in side at the time of forward moving, the support plate portion 133 illustrated in FIG. 8 of the turning-in-side side pushing spring 131 of the turning-in-side pad spring 24 on the outer side and causes the support plate portion 133 to be elastically deformed outward in the disc rotation direction so as to cause the support plate portion 133 to approach the outward-side plate portion 111 of the turning-in-side pad spring 24.

Also, at that time, the turning-out-side ear portion 176(b) of the second friction pad 27 illustrated in FIG. 6 abuts, on its inward-side surface portion 191 on the inward side in the disc radial direction, the inward-side support plate portion 123 illustrated in FIG. 11 of the turning-out-side pushing-up spring 121(b) of the turning-out-side pad spring 25 on the outer side and is inserted into the guide recessed portion 153 disposed at the fourth attachment portion 52 as illustrated in FIG. 6 with the inward-side support plate portion 123 elastically deformed inward in the disc radial direction so as to cause the inward-side support plate portion 123 to approach the stretching-out plate portion 114. Also, at that time, the main body portion 185 of the second friction pad 27 abuts, on the turning-out-side friction pad portion 184(b) on the turning-out side at the time of forward moving out of the pair of turning-in-side friction pad portion 184(a) and the turning-out-side friction pad portion 184(b), the support plate portion 158 illustrated in FIG. 8 of the turning-out-side side pushing spring 152 of the turning-out-side pad spring 25 on the outer side and elastically deforms the support plate portion 158 outward in the disc rotation direction so as to cause the support plate portion 158 to approach the outward-side plate portion 111 of the turning-out-side pad spring 25.

At this time, the turning-out-side side pushing spring 152 out of the turning-in-side side pushing spring 131 and the turning-out-side side pushing spring 152, both of which bias the second friction pad 27 in opposite directions in the disc rotation direction has a smaller spring constant than the turning-in-side side pushing spring 131. Therefore, the turning-in-side side pushing spring 131 has a larger force of biasing the second friction pad 27 in a direction away from the disc 11 in the disc axis direction than the turning-out-side side pushing spring 152. Also, the turning-in-side side pushing spring 131 has a larger force of biasing the second friction pad 27 inward in the disc rotation direction than the turning-out-side side pushing spring 152.

As described above, the second friction pad 27 is supported by the third attachment portion 51 with the turning-in-side ear portion 176(a) inserted into the turning-in-side ear accommodating portion 75(a) of the third attachment portion 51 of the attachment member 20.

Along with this, the second friction pad 27 is supported by the fourth attachment portion 52 with the turning-out-side ear portion 176(b) inserted into the turning-out-side ear accommodating portion 75(b) of the fourth attachment portion 52 of the attachment member 20. In other words, the attachment member 20 includes the turning-out-side ear accommodating portion 75(b) in which the turning-out-side ear portion 176(b) of the second friction pad 27 is accommodated and the turning-in-side ear accommodating portion 75(a) in which the turning-in-side ear portion 176(a) of the second friction pad 27 is accommodated.

In this state, the turning-in-side ear portion 176(a) of the second friction pad 27 is pressed outward in the disc radial direction with the biasing force of the turning-in-side pushing-up spring 121(a) of the turning-in-side pad spring 24 on the outer side. In other words, the turning-in-side pushing-up spring 121(a) of the turning-in-side pad spring 24 on the outer side elastically supports the second friction pad 27 in the disc radial direction. In yet other words, the turning-in-side pad spring 24 includes the turning-in-side pushing-up spring 121(a) that biases, on the outward side in the disc radial direction, the turning-in-side ear portion 176(a) of the second friction pad 27 on the turning-in side at the time of forward moving.

Also, in this state, the turning-in-side side pushing spring 131 of the pad support portion 101 of the turning-in-side pad spring 24 on the outer side is disposed at the second friction pad 27 on the outward side of the turning-in-side ear portion 176(a) in the disc radial direction.

Moreover, in this state, the main body portion 185 of the second friction pad 27 is pressed on the turning-out side at the time of forward moving with the biasing force of the turning-in-side side pushing spring 131 of the turning-in-side pad spring 24 on the outer side. In other words, the turning-in-side side pushing spring 131 of the turning-in-side pad spring 24 on the outer side elastically supports the second friction pad 27 in the disc rotation direction.

Also, in this state, the turning-out-side ear portion 176(b) of the second friction pad 27 is pressed outward in the disc radial direction with the biasing force of the turning-out-side pushing-up spring 121(b) of the turning-out-side pad spring 25 on the outer side. In other words, the turning-out-side pushing-up spring 121(b) of the turning-out-side pad spring 25 on the outer side elastically supports the second friction pad 27 in the disc radial direction. In yet other words, the turning-out-side pad spring 25 includes the turning-in-side pushing-up spring 121(b) that biases, on the outward side in the disc radial direction, the turning-out-side ear portion 176(b) of the second friction pad 27 on the turning-out side at the time of forward moving.

Also, in this state, the turning-out-side side pushing spring 152 of the pad support portion 151 of the turning-out-side pad spring 25 on the outer side is disposed at the second friction pad 27 on the outward side of the turning-out-side ear portion 176(b) in the disc radial direction.

Also, in this state, the main body portion 185 of the second friction pad 27 is pressed on the turning-in-side at the time of forward moving with the biasing force of the turning-out-side side pushing spring 152 of the turning-out-side pad spring 25 on the outer side. In other words, the turning-out-side side pushing spring 152 of the turning-out-side pad spring 25 on the outer side elastically supports the second friction pad 27 in the disc rotation direction.

As described above, the second friction pad 27 is biased outward in the disc radial direction with the biasing force of the turning-in-side pushing-up spring 121(a) of the turning-in-side pad spring 24 on the outer side and the turning-out-side pushing-up spring 121(b) of the turning-out-side pad spring 25 on the outer side. In the thus biased second friction pad 27, the turning-in-side ear portion 176(a) is pressed against and is brought into surface contact with the outward-side support plate portion 112 of the guide recessed portion 120 of the turning-in-side pad spring 24 on the outer side, on its outward-side surface portion 192 in a state where there is no input from the disc 11. Also, in this state, the turning-out-side ear portion 176(b) of the second friction pad 27 is pressed against and is brought into surface contact with the outward-side support plate portion 112 of the guide recessed portion 120 of the turning-out-side pad spring 25 on the outer side, on its outward-side surface portion 192.

Also, in this state, the turning-in-side ear portion 176(a) of the second friction pad 27 is supported by the guide recessed portion 120 of the turning-in-side pad spring 24 on the outer side so as to be movable in the disc axis direction. Moreover, in this state, the turning-out-side ear portion 176(b) of the second friction pad 27 is supported by the guide recessed portion 120 of the turning-out-side pad spring 25 on the outer side so as to be movable in the disc axis direction.

In the second friction pad 27 biased toward the turning-out side at the time of forward moving with the biasing force of the turning-in-side side pushing spring 131 of the turning-in-side pad spring 24 on the outer side, the turning-out-side ear portion 176(b) is pressed against and is brought into surface contact with the wall plate portion 154 of the guide recessed portion 153 of the turning-out-side pad spring 25 on the outer side, on its distal end surface portion 193 at its outer end in the disc rotation direction in a state where there is no input from the disc 11.

Also, in this state, the second friction pad 27 is brought into a state where the distal end surface portion 193 of the turning-in-side ear portion 176(a) has a clearance S in the disc rotation direction with the wall plate portion 113 of the guide recessed portion 120 of the turning-in-side pad spring 24 on the outer side without coming into contact with the wall plate portion 113 as illustrated in FIG. 7.

Therefore, the size of the clearance between the turning-out-side ear portion 176(b) of the second friction pad 27 on the turning-out side at the time of forward moving and the turning-out-side ear accommodating portion 75(b) in which the turning-out-side ear portion 176(b) of the attachment member 20 is accommodated in the disc rotation direction is smaller than the size of the clearance S between the turning-in-side ear portion 176(a) of the second friction pad 27 on the turning-in side at the time of forward moving and the turning-in-side ear accommodating portion 75(a) in which the turning-in-side ear portion 176(a) of the attachment member 20 is accommodated in the disc rotation direction.

The guide recessed portion 120 of the turning-in-side pad spring 24 on the outer side includes a wall plate portion 113 that is curved from the third surface portion 63 of the torque receiving portion 60 of the third attachment portion 51 toward the second friction pad 27. The wall plate portion 113 also elastically supports the second friction pad 27 in the disc rotation direction once the distal end surface portion 193 of the turning-in-side ear portion 176(a) of the second friction pad 27 abuts the wall plate portion 13. Here, the turning-in-side side pushing spring 131 out of the turning-in-side side pushing spring 131 and the wall plate portion 113, both of which are on the outer side of the turning-in-side pad spring 24, has a smaller spring constant than the spring constant of the wall plate portion 113.

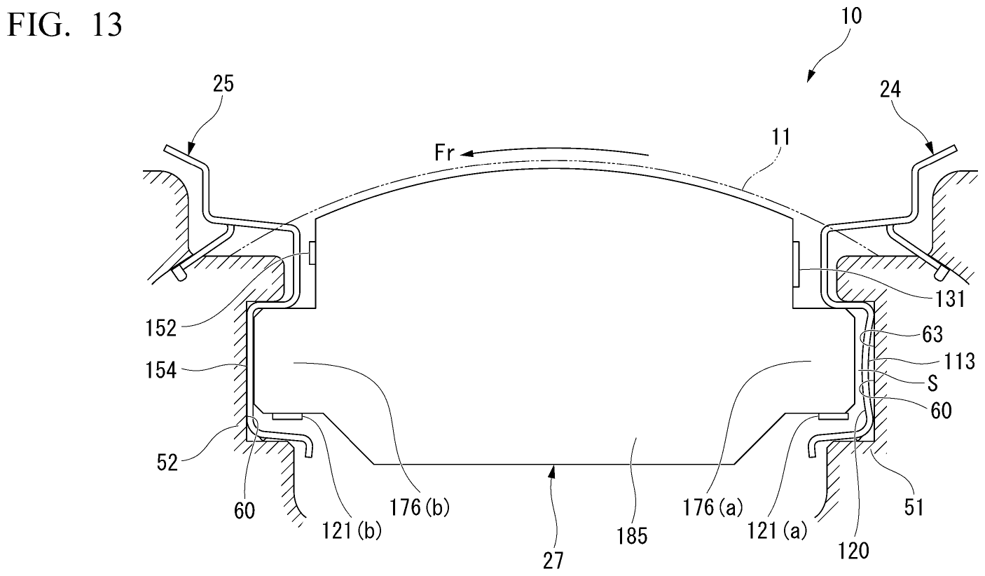

For the disc brake 10, the state described above is a first state in which one of the turning-in-side side pushing spring 131 and the wall plate portion 113, both of which are on the outer side of the turning-in-side pad spring 24, abuts the second friction pad 27 while the other one has the clearance S with the second friction pad 27 as schematically illustrated in FIG. 13. The turning-in-side side pushing spring 131 of the turning-in-side pad spring 24 on the outer side is disposed on the side further outward in the disc radial direction than the wall plate portion 113 on the outer side. The first state is a state in which the second friction pad 27 has the clearance S with the wall plate portion 113 of the turning-in-side pad spring 24 on the outer side through the support of the turning-in-side side pushing spring 131 of the turning-in-side pad spring 24 on the outer side.

The turning-in-side pad spring 24 includes the turning-in-side pushing-up spring 121(a) that abuts the second friction pad 27 and supports, on the outward side in the disc radial direction, the second friction pad 27 on the outer side. The apex of the curve of the wall plate portion 113 of the turning-in-side pad spring 24 on the outer side abuts the center of the ear portion 176 of the second friction pad 27 on the turning-out side at the time of backward moving in the direction of the reference line in the disc radial direction, at the time of braking of backward moving of the vehicle.

As illustrated in FIG. 3, the turning-in-side ear portion 176(a) of the first friction pad 26 is engaged with the pad support portion 101 on the inner side attached to the first attachment portion 46 of the turning-in-side pad spring 24. The turning-out-side ear portion 176(b) of the first friction pad 26 is engaged with the pad support portion 151 on the inner side attached to the second attachment portion 47 of the turning-out-side pad spring 25. In this manner, the longitudinal direction of the first friction pad 26 is aligned with the disc rotation direction.

Here, when the first friction pad 26 is attached to the attachment member 20 via the turning-in-side pad spring 24 and the turning-out-side pad spring 25, the turning-in-side ear portion 176(a) of the first friction pad 26 abuts, on its inward-side surface portion 191 on the inward side in the disc radial direction, the inward-side support plate portion 123 illustrated in FIG. 8 of the turning-in-side pushing-up spring 121(a) of the turning-in-side pad spring 24 on the inner side and is inserted into the guide recessed portion 120 on the inner side of the turning-in-side pad spring 24 disposed at the first attachment portion 46 as illustrated in FIG. 3 with the inward-side support plate portion 123 elastically deformed inward in the disc radial direction so as to cause the inward-side support plate portion 123 to approach the stretching-out plate portion 114. At that time, the main body portion 185 of the first friction pad 26 abuts, on its turning-in-side friction pad portion 184(a), the support plate portion 133 illustrated in FIG. 8 of the turning-in-side side pushing spring 131 of the turning-in-side pad spring 24 on the inner side and elastically deforms the support plate portion 133 outward in the disc rotation direction so as to cause the support plate portion 133 to approach the outward-side plate portion 111 of the turning-in-side pad spring 24.

Also, at that time, the turning-out-side ear portion 176(b) of the first friction pad 26 illustrated in FIG. 3 abuts, on the inward-side surface portion 191 on the inward side in the disc radial direction, the inward-side support plate portion 123 illustrated in FIG. 11 of the turning-out-side pushing-up spring 121(b) of the turning-out-side pad spring 25 on the inner side and is inserted into the guide recessed portion 153 disposed at the second attachment portion 47 as illustrated in FIG. 3 with the inward-side support plate portion 123 elastically deformed inward in the disc radial direction so as to cause the inward-side support plate portion 123 to approach the stretching-out plate portion 114. Also, at that time, the main body portion 185 of the first friction pad 26 abuts, on its turning-out-side friction pad portion 184(b), the support plate portion 158 illustrated in FIG. 11 of the turning-out-side side pushing spring 152 of the turning-out-side pad spring 25 on the inner side and elastically deforms the support plate portion 158 outward in the disc rotation direction so as to cause the support plate portion 158 to approach the outward-side plate portion 111 of the turning-out-side pad spring 25.

At this time, the turning-out-side side pushing spring 152 out of the turning-in-side side pushing spring 131 and the turning-out-side side pushing spring 152, both of which bias the first friction pad 26 in opposite directions in the disc rotation direction has a smaller spring constant than the turning-in-side side pushing spring 131. Therefore, the turning-in-side side pushing spring 131 has a larger force of biasing the first friction pad 26 in a direction away from the disc 11 in the disc axis direction than the turning-out-side side pushing spring 152. Also, the turning-in-side side pushing spring 131 has a larger force of biasing the first friction pad 26 inward in the disc rotation direction than the turning-out-side side pushing spring 152.

As described above, the turning-in-side ear portion 176(a) of the first friction pad 26 is inserted into the turning-in-side ear accommodating portion 75(a) of the first attachment portion 46 of the attachment member 20 and is supported by the first attachment portion 46.

Along with this, the turning-out-side ear portion 176(b) of the first friction pad 26 is inserted into the turning-out-side ear accommodating portion 75(b) of the second attachment portion 47 of the attachment member 20 and is supported by the second attachment portion 47. In other words, the attachment member 20 includes the turning-in-side ear accommodating portion 75(a) in which the turning-in-side ear portion 176(a) of the first friction pad 26 is accommodated and the turning-out-side ear accommodating portion 75(b) in which the turning-out-side ear portion 176(b) of the first friction pad 26 is accommodated.

In this state, the turning-in-side ear portion 176(a) of the first friction pad 26 is pressed outward in the disc radial direction with the biasing force of the turning-in-side pushing-up spring 121(a) of the turning-in-side pad spring 24 on the inner side. In other words, the turning-in-side pushing-up spring 121(a) of the turning-in-side pad spring 24 on the inner side elastically supports the first friction pad 26 in the disc radial direction. In yet other words, the turning-in-side pad spring 24 includes the turning-in-side pushing-up spring 121(a) that biases, on the outward side in the disc radial direction, the turning-in-side ear portion 176(a) of the first friction pad 26 on the turning-in side at the time of forward moving.

Also, in this state, the turning-in-side side pushing spring 131 of the pad support portion 101 of the turning-in-side pad spring 24 on the inner side is disposed at the first friction pad 26 on the outward side of the turning-in-side ear portion 176(a) in the disc radial direction.

Moreover, in this state, the main body portion 185 of the first friction pad 26 is pressed on the turning-out side at the time of forward moving with the biasing force of the turning-in-side side pushing spring 131 of the turning-in-side pad spring 24 on the inner side. In other words, the turning-in-side side pushing spring 131 of the turning-in-side pad spring 24 on the inner side elastically supports the first friction pad 26 in the disc rotation direction.

Also, in this state, the turning-out-side ear portion 176(b) of the first friction pad 26 is pressed outward in the disc radial direction with the biasing force of the turning-out-side pushing-up spring 121(b) of the turning-out-side pad spring 25 on the inner side. In other words, the turning-out-side pushing-up spring 121(b) of the turning-out-side pad spring 25 on the inner side elastically supports the first friction pad 26 in the disc radial direction. In yet other words, the turning-out-side pad spring 25 includes the turning-out-side pushing-up spring 121(b) that biases, on the outward side in the disc radial direction, the turning-out-side ear portion 176(b) of the first friction pad 26 on the turning-out side at the time of forward moving.

Also, in this state, the turning-out-side side pushing spring 152 of the pad support portion 151 of the turning-out-side pad spring 25 on the inner side is disposed at the first friction pad 26 on the outward side of the turning-out-side ear portion 176(b) in the disc radial direction.

Also, in this state, the main body portion 185 of the first friction pad 26 is pressed on the turning-in side at the time of forward moving with the biasing force of the turning-out-side side pushing spring 152 of the turning-out-side pad spring 25 on the inner side. In other words, the turning-out-side side pushing spring 152 of the turning-out-side pad spring 25 on the inner side elastically supports the first friction pad 26 in the disc rotation direction.

As described above, the first friction pad 26 is biased outward in the disc radial direction with the biasing force of the turning-in-side pushing-up spring 121(a) of the turning-in-side pad spring 24 on the inner side and the turning-out-side pushing-up spring 121(b) of the turning-out-side pad spring 25 on the inner side. The turning-in-side ear portion 176(a) of the thus biased first friction pad 26 is pressed against and is brought into surface contact with the outward-side support plate portion 112 of the guide recessed portion 120 of the turning-in-side pad spring 24 on the inner side, on its outward-side surface portion 192 in a state where there is no input from the disc 11. Also, in this state, the turning-out-side ear portion 176(b) of the first friction pad 26 is pressed against and is brought into surface contact with the outward-side support plate portion 112 of the guide recessed portion 120 of the turning-out-side pad spring 25 on the inner side, on its outward-side surface portion 192.

Also, in this state, the turning-in-side ear portion 176(a) of the first friction pad 26 is supported by the guide recessed portion 120 of the turning-in-side pad spring 24 on the inner side so as to be movable in the disc axis direction. Also, in this state, the turning-out-side ear portion 176(b) of the first friction pad 26 is supported by the guide recessed portion 120 of the turning-out-side pad spring 25 on the inner side so as to be movable in the disc axis direction.

The turning-out-side ear portion 176(b) of the first friction pad 26 that is biased toward the turning-out side at the time of forward moving with the biasing force of the turning-in-side side pushing spring 131 of the turning-in-side pad spring 24 on the inner side is pressed against and is brought into surface contact with the wall plate portion 154 of the guide recessed portion 153 of the turning-out-side pad spring 25 on the outer side, on its distal end surface portion 193 at its outer end in the disc rotation direction in a state where there is no input from the disc 11.

Also, in this state, the first friction pad 26 is brought into a state where the distal end surface portion 193 of the turning-in-side ear portion 176(a) does not come into contact with the wall plate portion 113 of the guide recessed portion 120 of the turning-in-side pad spring 24 on the outer side and has the clearance S in the disc rotation direction with the wall plate portion 113.

Therefore, the size of the clearance between the turning-out-side ear portion 176(b) of the first friction pad 26 on the turning-out side at the time of forward moving in the disc rotation direction and the turning-out-side ear accommodating portion 75(b) in which the turning-out-side ear portion 176(b) is accommodated in the attachment member 20 in the disc rotation direction is smaller than the size of the clearance S between the turning-in-side ear portion 176(a) of the first friction pad 26 on the turning-in side at the time of forward moving and the turning-in-side ear accommodating portion 75(a) in which the turning-in-side ear portion 176(a) is accommodated in the attachment member 20 in the disc rotation direction.

The guide recessed portion 120 of the turning-in-side pad spring 24 on the inner side includes the wall plate portion 113 that is curved from the third surface portion 63 of the torque receiving portion 60 of the first attachment portion 46 toward the first friction pad 26. The wall plate portion 113 also elastically supports the first friction pad 26 in the disc rotation direction once the distal end surface portion 193 of the turning-in-side ear portion 176(a) of the first friction pad 26 abuts the wall plate portion 113. Here, the turning-in-side side pushing spring 131 out of the turning-in-side side pushing spring 131 and the wall plate portion 113, both of which are on the inner side of the turning-in-side pad spring 24, has a smaller spring constant than the spring constant of the wall plate portion 113.

For the disc brake 10, the aforementioned state is a first state where one of the turning-in-side side pushing spring 131 and the wall plate portion 113, both of which are on the inner side of the turning-in-side pad spring 24, abuts the first friction pad 26 and the other one has a clearance S with the first friction pad 26. The turning-in-side side pushing spring 131 of the turning-in-side pad spring 24 on the inner side is disposed on the side further outward than the wall plate portion 113 on the inner side in the disc radial direction. The first state is a state where the first friction pad 26 has the clearance S with the wall plate portion 113 of the turning-in-side pad spring 24 on the inner side through the support of the turning-in-side side pushing spring 131 of the turning-in-side pad spring 24 on the inner side.

The turning-in-side pad spring 24 includes, on the inner side, the turning-in-side pushing-up spring 121(a) that abuts the first friction pad 26 and supports the first friction pad 26 on the outward side in the disc radial direction. The apex of the curve of the wall plate portion 113 of the turning-in-side pad spring 24 on the inner side abuts the center of the turning-in-side ear portion 176(a) of the first friction pad 26 on the turning-out side at the time of backward moving in the direction of the reference line in the disc radial direction, at the time of braking of backward moving of the vehicle.

As illustrated in FIG. 2, the second friction pad 27 on the outer side is brought into a state where the distal end surface 174 of the lining 173 on the side opposite to the rear plate 172 is caused to face the second side surface 13 of the disc 11 on the outer side. The first friction pad 26 on the inner side is brought into a state where the distal end surface 174 of the lining 173 on the side opposite to the rear plate 172 is caused to face the first side surface 12 of the disc 11 on the inner side. The second friction pad 27 comes into contact with the second side surface 13 of the disc 11 at the distal end surface 174 of the lining 173 on the side opposite to the rear plate 172 at the time of braking. The first friction pad 26 comes into contact with the first side surface 12 of the disc 11 at the distal end surface 174 of the lining 173 on the side opposite to the rear plate 171 at the time of braking.

As illustrated in FIG. 3, the abrasion sensor 183 attached to the first friction pad 26 on the inner side is disposed at the first friction pad 26 on the turning-in side at the time of forward moving.

The turning-in-side return spring 196(a) and the turning-out-side return spring 196(b) are fixed to the first friction pad 26 on the inner side at a position of the turning-in-side ear portion 176(a) on one side in the disc rotation direction of the rear surface 161 on the side opposite to the distal end surface 174 abutting the disc 11 and at a position of the turning-out-side ear portion 176(b) of the rear surface 161 on the other side in the disc rotation direction, respectively. In other words, the pair of turning-in-side return spring 196(a) and turning-out-side return spring 196(b) provided in the first friction pad 26 on the inner side are disposed on both end sides of the first friction pad 26 in the disc rotation direction.

The turning-in-side return spring 196(a) fixed to the rear surface 161 of the first friction pad 26 on the turning-in side at the time of forward moving out of the pair of turning-in-side return spring 196(a) and turning-out-side return spring 196(b) abuts, in the disc axis direction, the turning-in-side abutting surface portion 164 of the first attachment portion 46 of the attachment member 20 on the turning-in-side at the time of forward moving on the side opposite to the disc 11 in the disc axis direction. The turning-out-side return spring 196(b) fixed to the rear surface 161 of the first friction pad 26 on the turning-out side at the time of forward moving out of the pair of turning-in-side return spring 196(a) and turning-out-side return spring 196(b) abuts, in the disc axis direction, the turning-out-side abutting surface portion 165 of the second attachment portion 47 of the attachment member 20 on the turning-out side at the time of forward moving on the side opposite to the disc 11 in the disc axis direction. The pair of turning-in-side return spring 196(a) and turning-out-side return spring 196(b) provided in the first friction pad 26 biases the first friction pad 26 that has moved on the side of the disc 11 in the disc axis direction with respect to the attachment member 20 in a direction away from the disc 11 in the disc axis direction.

As illustrated in FIG. 6, the turning-in-side return spring 196(a) and the turning-out-side return spring 196(b) are fixed to the second friction pad 27 on the outer side at a position of the turning-in-side ear portion 176(a) of the rear surface 162 on the side opposite to the distal end surface 174 abutting the disc 11 on one side in the disc rotation direction and at a position of the turning-out-side ear portion 176(b) of the rear surface 161 on the other side in the disc rotation direction, respectively.

In other words, the pair of turning-in-side return spring 196(a) and turning-out-side return spring 196(b) provided in the second friction pad 27 on the outer side are disposed on both end sides of the second friction pad 27 in the disc rotation direction.

The turning-in-side return spring 196(a) fixed to the rear surface 162 of the second friction pad 27 on the turning-in side at the time of forward moving out of the pair of turning-in-side return spring 196(a) and turning-out-side return spring 196(b) abuts, in the disc axis direction, the turning-in-side abutting surface portion 167 of the third attachment portion 51 of the attachment member 20 on the turning-in side at the time of forward moving on the side opposite to the disc 11 in the disc axis direction. The turning-out-side return spring 196(b) fixed to the rear surface 162 of the second friction pad 27 on the turning-out side at the time of forward moving out of the pair of turning-in-side return spring 196(a) and turning-out-side return spring 196(b) abuts, in the disc axis direction, the turning-out-side abutting surface portion 168 of the fourth attachment portion 52 of the attachment member 20 on the turning-out side at the time of forward moving on the side opposite to the disc 11 in the disc axis direction. The pair of turning-in-side return spring 196(a) and turning-out-side return spring 196(b) provided in the second friction pad 27 bias the second friction pad 27, which has moved on the side of the disc 11 in the disc axis direction with respect to the attachment member 20, in the direction away from the disc 11 in the disc axis direction.

In the disc brake 10, the total of four return springs, namely the pair of turning-in-side return spring 196(a) and the turning-out-side return spring 196(b), both of which are attached to the first friction pad 26 illustrated in FIG. 3, and the pair of turning-in-side return spring 196(a) and the turning-out-side return spring 196(b), both of which are attached to the second friction pad 27 illustrated in FIG. 6, bias the pair of first friction pad 26 and second friction pad 27 in the direction away from the disc 11 in the disc axis direction. In the disc brake 10, the four return springs, namely the pair of turning-in-side return spring 196(a) and turning-out-side return spring 196(b), both of which are attached to the first friction pad 26 illustrated in FIG. 3, and the pair of turning-in-side return spring 196(a) and turning-out-side return spring 196(b), both of which are attached to the second friction pad 27 illustrated in FIG. 6 have the same properties. In other words, the turning-in-side return spring 196(a) and the turning-out-side return spring 196(b), both of which are attached to the first friction pad 26 illustrated in FIG. 3, have the same properties. Moreover, the turning-in-side return spring 196(a) and the turning-out-side return spring 196(b), both of which are attached to the second friction pad 27 illustrated in FIG. 6, have the same properties.

The turning-out-side side pushing spring 152 out of the turning-in-side side pushing spring 131 and the turning-out-side side pushing spring 152, both of which bias the first friction pad 26 illustrated in FIG. 3 in opposite directions in the disc rotation direction has a smaller spring constant than the turning-in-side side pushing spring 131. Also, the turning-out-side side pushing spring 152 out of the turning-in-side side pushing spring 131 and the turning-out-side side pushing spring 152, both of which bias the second friction pad 27 illustrated in FIG. 6 in opposite directions in the disc rotation direction has a smaller spring constant than the turning-in-side side pushing spring 131.

Therefore, the turning-in-side pad spring 24 includes the turning-in-side side pushing spring 131 that generates a first biasing force of biasing the turning-in-side friction pad portion 184(a) of the first friction pad 26 on the turning-in side at the time of forward moving, on the turning-out side at the time of forward moving and in the direction away from the disc 11 in the disc axis direction. Also, the turning-out-side pad spring 25 includes the turning-out-side side pushing spring 152 that generates a second biasing force of biasing the turning-out-side friction pad portion 184(b) of the first friction pad 26 on the turning-out side at the time of forward moving, on the turning-in side at the time of forward moving and in the direction away from the disc 11 in the disc axis direction. Moreover, the second biasing force that the turning-out-side side pushing spring 152 generates for the first friction pad 26 is smaller than the first biasing force that the turning-in-side side pushing spring 131 generates for the first friction pad 26.

Also, the turning-in-side pad spring 24 includes the turning-in-side side pushing spring 131 that generates a first biasing force of biasing the turning-in-side friction pad portion 184(a) of the second friction pad 27 on the turning-in side at the time of forward moving, on the turning-out side at the time of forward moving and in the direction away from the disc 11 in the disc axis direction. Moreover, the turning-out-side pad spring 25 includes the turning-out-side side pushing spring 152 that generates a second biasing force of biasing the turning-out-side friction pad portion 184(b) of the second friction pad 27 on the turning-out side at the time of forward moving, on the turning-in side at the time of forward moving and in the direction away from the disc 11 in the disc axis direction. Additionally, the second biasing force that the turning-out-side side pushing spring 152 generates for the second friction pad 27 is smaller than the first biasing force that the turning-in-side side pushing spring 131 generates for the second friction pad 27.

Additionally, the turning-in-side return spring 196(a) and the turning-out-side return spring 196(b), both of which bias the first friction pad 26 in the direction away from the disc 11, have the same properties. Also, the turning-in-side return spring 196(a) and the turning-out-side return spring 196(b), both of which bias the second friction pad 27 in the direction away from the disc 11, have the same properties.

A resultant force of the turning-in-side return spring 196(a) and the turning-in-side pad spring 24, which is a force of biasing the turning-in-side friction pad portion 184(a) of the first friction pad 26 on the turning-in side at the time of forward moving in the direction away from the disc 11 in the disc axis direction is defined as a turning-in-side returning force. Also, a resultant force of the turning-out-side return spring 196(b) and the turning-out-side pad spring 25, which is a force of biasing the turning-out-side friction pad portion 184(b) of the first friction pad 26 on the turning-out side at the time of forward moving in the direction away from the disc 11 is defined as a turning-out-side returning force. Moreover, the turning-in-side returning force of the first friction pad 26 is larger than the turning-out-side returning force of the first friction pad 26. Therefore, it is possible to cause the spring constant of the turning-in-side return spring 196(a) to be attached to the first friction pad 26 to be larger than the spring constant of the turning-out-side return spring 196(b) to be attached to the first friction pad 26 and thereby to cause the turning-in-side returning force to be yet larger than the turning-out-side returning force, by differentiating materials and shapes.

A resultant force of the turning-in-side return spring 196(a) and the turning-in-side pad spring 24, which is a force of biasing the turning-in-side friction pad portion 184(a) of the second friction pad 27 on the turning-in side at the time of forward moving in the direction away from the disc 11 in the disc axis direction is defined as a turning-in-side returning force. Also, a resultant force of the turning-out-side return spring 196(b) and the turning-out-side pad spring 25, which is a force of biasing the turning-out-side friction pad portion 184(b) of the second friction pad 27 on the turning-out side at the time of forward moving in the direction away from the disc 11 in the disc axis direction is defined as a turning-out-side returning force. Moreover, the turning-in-side returning force of the second friction pad 27 is larger than the turning-out-side returning force of the second friction pad 27. Note that it is possible to cause the spring constant of the turning-in-side return spring 196(a) to be attached to the second friction pad 27 to be larger than the spring constant of the turning-out-side return spring 196(b) to be attached to the second friction pad 27 and to cause the turning-in-side returning force to be yet larger than the turning-out-side returning force, by differentiating materials and shapes.

As illustrated in FIG. 1, the caliper 21 includes a caliper main body 201, a turning-in-side slide pin 202, a turning-out-side slide pin 203, a turning-in-side attachment bolt 204, a turning-out-side attachment bolt, which is not illustrated, and a piston, which is not illustrated.

The caliper 21 has a mirror symmetrical shape, and the reference line in the radial direction and the reference plane in the radial direction pass through the center position of the caliper 21 in the disc rotation direction. In the caliper 21, the turning-in-side slide pin 202 is fixed to the caliper main body 201 with a turning-in-side attachment bolt 204. Also, in the caliper 21, the positions of the turning-out-side slide pin 203 are fixed to the caliper main body 201 with a turning-out-side attachment bolt, which is not illustrated. The pair of turning-in-side slide pin 202 and turning-out-side slide pin 203 in the axial direction are aligned with each other, and also they are disposed to be parallel with each other.

A turning-in-side pin insertion hole that extends in the disc axis direction from an end surface of the turning-in-side coupling portion 33 on the inner side to a midway point inside the turning-in-side coupling portion 33 and is not illustrated in the drawing is formed in the attachment member 20.

A turning-out-side pin insertion hole that extends in the disc axis direction from an end surface of the turning-out-side coupling portion 34 on the inner side to a midway position inside the turning-out-side coupling portion 34 and is not illustrated in the drawing is formed in the attachment member 20. In the caliper 21, the turning-in-side side pin 202 is slidably fitted into a turning-in-side pin insertion hole, which is not illustrated, of the attachment member 20. Also, in the caliper 21, the turning-out-side slide pin 203 is slidably fitted to a turning-out-side pin insertion hole, which is not illustrated, of the attachment member 20.

In this manner, the caliper main body 201 of the caliper 21 is provided at the attachment member 20 via the turning-in-side slide pin 202 and the turning-out-side slide pin 203 so as to be movable in the disc axis direction. In other words, the attachment member 20 supports the caliper 21 at the pair of turning-in-side coupling portion 33 and turning-out-side coupling portion 34 such that the caliper 21 is slidable in the disc axis direction. Therefore, the caliper 21 is provided in the attachment member 20 to be movable in the disc axis direction. The turning-in-side pin boot 22 covers a part of the turning-in-side slide pin 202 projecting from the attachment member 20. A turning-out-side pin boot 23 covers a part of the turning-out-side slide pin 203 projecting from the attachment member 20.

The caliper main body 201 has a substantially mirror symmetrical shape. The reference line in the radial direction and the reference plane in the radial direction pass through the center position of the caliper main body 201 in the disc rotation direction. The caliper main body 201 includes a cylinder portion 221, a bridge portion 222, a claw portion 223, a turning-in-side pin disposition portion 224, and a turning-out-side pin disposition portion 225

The cylinder portion 221 is disposed on the inner side in the disc axis direction with respect to the disc 11.

The bridge portion 222 stretches out on the outer side in the disc axis direction so as to straddle the outer periphery of the disc 11 from a part of the cylinder portion 221 on the outward side in the disc radial direction. The claw portion 223 stretches out on the inward side in the disc radial direction from a part of the bridge portion 222 on the side opposite to the cylinder portion 221 and is disposed on the further outer side as compared with the disc 11. The turning-in-side pin disposition portion 224 is disposed on the further turning-in side at the time of forward moving as compared with the cylinder portion 221. The turning-out-side pin disposition portion 225 is disposed on the further turning-out side at the time of forward moving as compared with the cylinder portion 221. The turning-in-side slide pin 202 is fixed to the turning-in-side pin disposition portion 224 of the caliper main body 201 with a turning-in-side attachment bolt 204. The turning-out-side slide pin 203 is fixed to the turning-out-side pin disposition portion 225 of the caliper main body 201 with a turning-out-side attachment bolt, which is not illustrated.

Cylinder holes, which are not illustrated, are formed in the cylinder portion 221. The cylinder holes, which are not illustrated, are recessed in a direction opposite to the disc 11 from an end surface of the cylinder portion 221 on the side of the disc 11 in the disc axis direction. Therefore, the cylinder holes, which are not illustrated, are open on the side of the disc 11. The cylinder holes, which are not illustrated, follow the disc axis direction. The cylinder holes, which are not illustrated, are formed at a plurality of locations, specifically two locations in an aligned manner in the disc rotation direction in the cylinder portion 221. A piston, which is not illustrated, is accommodated in each of the cylinder holes, which are not illustrated. Therefore, the caliper 21 is a two-pot-type caliper. The claw portion 223 is provided to face the cylinder portion 221 in the disc axis direction.

The pistons, which are not illustrated, are accommodated in the cylinder holes, which are not illustrated, of the cylinder portion 221 so as to be movable in the disc axis direction. The pistons, which are not illustrated, face the first side surface 12 of the disc 11. The first friction pad 26 is disposed between the first side surface 12 of the disc 11 and the pistons, which are not illustrated. The pistons, which are not illustrated, press the first friction pad 26 as the pistons move forward toward the first side surface 12 of the disc 11.

At the time of braking during forward traveling of the vehicle, a brake fluid is introduced between the cylinder holes, which are not illustrated, and the pistons, which are not illustrated, of the cylinder portion 221 of the caliper 21 via a brake pipe, which is not illustrated, in the disc brake 10. Then, a brake fluid pressure acts on the pistons, which are not illustrated, at the cylinder portion 221 of the caliper 21, and the pistons, which are not illustrated, move forward on the side of the disc 11.

The pistons, which are not illustrated, that move forward in this manner press the first friction pad 26 on the inner side disposed between itself and the disc 11 toward the disc 11. Then, the first friction pad 26 on the inner side is guided by the attachment member 20 via the turning-in-side pad spring 24 and the turning-out-side pad spring 25, moves on the side of the disc 11 in the disc axis direction, comes into contact with the first side surface 12 of the disc 11 on one side at the distal end surface 174 of the lining 173 illustrated in FIG. 5, and is pressed against the disc 11.

Once the first friction pad 26 moves on the side of the disc 11 in the disc axis direction in this manner, the first friction pad 26 elastically deforms the turning-in-side return spring 196(a) and the turning-out-side return spring 196(b) illustrated in FIG. 3, both of which are attached to the first friction pad 26, in the disc axis direction. Along with this, the first friction pad 26 elastically deforms the turning-in-side side pushing spring 131 on the inner side and the turning-out-side side pushing spring 152 on the inner side illustrated in FIG. 5, both of which abut the first friction pad 26, in the disc rotation direction. At that time, the turning-in-side side pushing spring 131 on the inner side elastically deforms the support plate portion 133 so as to cause the support plate portion 133 to approach the outward-side plate portion 111 in the disc rotation direction, and the turning-out-side side pushing spring 152 on the inner side elastically deforms the support plate portion 158 so as to cause the support plate portion 158 to approach the outward-side plate portion 111 in the disc rotation direction.

Once the first friction pad 26 on the inner side is pressed against the disc 11 by the distal end surface 174 of the lining 173, the first friction pad 26 on the inner side is also pressed against the turning-out side at the time of forward moving with a friction force with the rotating disc 11. Then, the torque receiving portion 60 of the second attachment portion 47 of the attachment member 20 on the turning-out side at the time of forward moving as illustrated in FIG. 3 and on the inner side receives a braking torque from the turning-out-side ear portion 176(b) of the first friction pad 26 via the wall plate portion 154 of the guide recessed portion 153 of the turning-out-side pad spring 25 on the inner side.

The caliper main body 201 of the caliper 21 illustrated in FIG. 1 causes the turning-in-side slide pin 202 and the turning-out-side slide pin 203 to slide and move in the disc axis direction with respect to the attachment member 20 with a reactive force of pressing of the first friction pad 26 against the disc 11 caused by the pistons which are not illustrated. Then, the claw portion 223 of the caliper main body 201 presses the second friction pad 27 on the outer side disposed between the claw portion 223 and the disc 11 toward the disc 11. Then, the second friction pad 27 on the outer side is guided by the attachment member 20 via the turning-in-side pad spring 24 and the turning-out-side pad spring 25, moves on the side of the disc 11 in the disc axis direction, comes into contact with the second side surface 13 of the disc 11 on the other side, at its distal end surface 174 of the lining 173 illustrated in FIG. 5, and is pressed against the disc 11.

Once the second friction pad 27 moves on the side of the disc 11 in the disc axis direction in this manner, the second friction pad 27 elastically deforms the turning-in-side return spring 196(a) and the turning-out-side return spring 196(b) illustrated in FIG. 6, both of which are attached to the second friction pad 27 in the disc rotation direction. Along with this, the second friction pad 27 elastically deforms the turning-in-side side pushing spring 131 on the outer side and the turning-out-side side pushing spring 152 on the outer side illustrated in FIG. 5, both of which abut the second friction pad 27, in the disc rotation direction. At that time, the turning-in-side side pushing spring 131 on the outer side elastically deforms the support plate portion 133 so as to cause the support plate portion 133 to approach the outward-side plate portion 111 in the disc rotation direction, and the turning-out-side side pushing spring 152 on the outer side elastically deforms the support plate portion 158 so as to cause the support plate portion 158 to approach the outward-side plate portion 111 in the disc rotation direction.

Once the second friction pad 27 on the outer side is pressed against the disc 11 at the distal end surface 174 of the lining 173, the second friction pad 27 on the outer side is also pressed on the turning-out side at the time of forward moving due to a frictional force caused with the rotating disc 11. Then, the torque receiving portion 60 of the fourth attachment portion 52 of the attachment member 20 on the turning-out side at the time of forward moving illustrated in FIG. 6 and on the outer side receives a braking torque from the turning-out-side ear portion 176(b) of the second friction pad 27 via the wall plate portion 154 of the guide recessed portion 153 of the turning-out-side pad spring 25 on the outer side.

The caliper 21 that is slidably supported by the attachment member 20 and is illustrated in FIG. 1 sandwiches the pair of first friction pad 26 and second friction pad 27 from both sides in the disc axis direction with the pistons, which are not illustrated, and the claw portion 223 through an operation of the pistons, which are not illustrated, in this manner. Then, the caliper 21 presses the first friction pad 26 against the first side surface 12 of the disc 11 and presses the second friction pad 27 against the second side surface 13 of the disc 11. As a result, the disc brake 10 applies a friction resistance to the disc 11 and causes a braking force to be generated. The caliper 21 is a so-called fist-type (slide type) caliper. The pair of first friction pad 26 and second friction pad 27 are provided in the attachment member 20 and are pressed against the first side surface 12 and the second side surface 13 of the disc 11 on both sides by the caliper 21 in the disc axis direction.

Once the braking is released, the braking fluid pressure to the pistons, which are not illustrated, of the caliper 21 is reduced. Then, the pistons are separated from the disc 11 in the disc axis direction, and the first friction pad 26 moves to be separated from the disc 11 in the disc axis direction with a biasing force of the turning-in-side return spring 196(a) and the turning-out-side return spring 196(b) illustrated in FIG. 3, both of which are attached to the first friction pad 26, and a biasing force of the turning-in-side side pushing spring 131 on the inner side and the turning-out-side side pushing spring 152 on the inner side illustrated in FIG. 5, both of which abut the first friction pad 26.

Once the brake fluid pressure to the pistons, which are not illustrated, is reduced, the second friction pad 27 moves to be separated from the disc 11 in the disc axis direction with a biasing force of the turning-in-side return spring 196(a) and the turning-out-side return spring 196(b) illustrated in FIG. 6, both of which are attached to the second friction pad 27, and a biasing force of the turning-in-side side pushing spring 131 on the outer side and the turning-out-side side pushing spring 152 on the outer side illustrated in FIG. 5, both of which abut the second friction pad 27. Then, the caliper 21 is pressed by the second friction pad 27, and the caliper main body 201 slides the turning-in-side slide pin 202 and the turning-out-side slide pin 203 with respect to the attachment member 20 so as to separate the claw portion 223 from the disc 11 in the disc axis direction and moves in the disc axis direction.

At this time, the second biasing force that the turning-out-side side pushing spring 152 of the turning-out-side pad spring 25 on the inner side generates to bias the turning-out-side friction pad portion 184(b) of the first friction pad 26 in the direction away from the disc 11 in the disc axis direction is smaller than the first biasing force that the turning-in-side side pushing spring 131 of the turning-in-side pad spring 24 on the inner side generates to bias the turning-in-side friction pad portion 184(a) of the first friction pad 26 in the direction away from the disc 11 in the disc axis direction. Also, at this time, the second biasing force that the turning-out-side side pushing spring 152 of the turning-out-side pad spring 25 on the outer side generates to bias the turning-out-side friction pad portion 184(b) of the second friction pad 27 in the direction away from the disc 11 in the disc axis direction is smaller than the first biasing force that the turning-in-side side pushing spring 131 of the turning-in-side pad spring 24 on the outer side generates to bias the turning-in-side friction pad portion 184(a) of the second friction pad 27 in the direction away from the disc 11 in the disc axis direction.

Therefore, the turning-in-side returning force that is a resultant force of the turning-in-side return spring 196(a) and the turning-in-side pad spring 24 to bias the turning-in-side friction pad portion 184(a) of the first friction pad 26 in the direction away from the disc 11 in the disc axis direction is larger than the turning-out-side returning force that is a resultant force of the turning-out-side return spring 196(b) and the turning-out-side pad spring 25 to bias the turning-out-side friction pad portion 184(b) of the first friction pad 26 in the direction away from the disc 11 in the disc axis direction. Therefore, turning-in-side friction pad portion 184(a) on the turning-in side at the time of forward moving is further separated from the disc 11 in the disc axis direction than the turning-out-side friction pad portion 184 on the turning-out side at the time of forward moving, in the first friction pad 26. Also, the turning-in-side returning force that is a resultant force of the turning-in-side return spring 196(a) and the turning-in-side pad spring 24 to bias the turning-in-side friction pad portion 184(a) of the second friction pad 27 in the direction away from the disc 11 in the disc axis direction is larger than the turning-out-side returning force that is the resultant force of the turning-out-side return spring 196(b) and the turning-out-side pad spring 25 to bias the turning-out-side friction pad portion 184(b) of the second friction pad 27 in the direction away from the disc 11 in the disc axis direction. Therefore, turning-in-side friction pad portion 184(a) on the turning-in side at the time of forward moving is further separated from the disc 11 in the disc axis direction than the turning-out-side friction pad portion 184(b) on the turning-out side at the time of forward moving in the disc axis direction, in the second friction pad 27.

At the time of braking during backward moving of the vehicle, the disc brake 10 presses the first friction pad 26 against the first side surface 12 of the disc 11 and presses the second friction pad 27 on the second side surface 13 of the disc 11, respectively, similarly to the above description. At that time, the first friction pad 26 and the second friction pad 27 are pressed on the turning-out side at the time of backward moving, which is opposite to the direction described above, by the disc 11 rotating in the direction opposite to the direction described above.

Then, the first friction pad 26 presses the turning-in-side side pushing spring 131 of the turning-in-side pad spring 24 on the inner side on the turning-out side at the time of backward moving with the turning-in-side friction pad portion 184(a) of the main body portion 175 on the turning-in side at the time of forward moving, which is the turning-out side at the time of backward moving, and elastically deforms the turning-in-side side pushing spring 131. Thereafter, the first friction pad 26 abuts the apex of the curve of the wall plate portion 113 of the turning-in-side pad spring 24 on the inner side at the center of the ear portion 176 on the turning-out side at the time of backward moving in the direction of the reference line in the disc radial direction. Thereafter, the ear portion 176 presses the wall plate portion 113 on the turning-out side at the time of backward moving and elastically deforms the wall plate portion 113, at its distal end surface portion 193. Thereafter, the wall plate portion 113 finally becomes a flat plate shape and is brought into a state in which it comes into a surface contact with the distal end surface portion 193 of the ear portion 176 of the first friction pad 26 on the turning-out side at the time of backward moving and the third surface portion 63 which is a torque receiving surface of the torque receiving portion 60 of the first attachment portion 46.

For the disc brake 10, this state is a second state in which the clearance between the distal end surface portion 193 of the ear portion 176 of the first friction pad 26 on the turning-out side at the time of backward moving and the wall plate portion 113 of the turning-in-side pad spring 24 on the inner side is filled due to the movement of the first friction pad 26. Once the second state is achieved, the torque receiving portion 60 of the first attachment portion 46 of the attachment member 20 on the turning-out side at the time of backward moving and on the inner side receives a braking torque from the ear portion 176 of the first friction pad 26 on the turning-out side at the time of backward moving via the wall plate portion 113 of the turning-in-side pad spring 24 on the inner side in the third surface portion 63.

Also, the second friction pad 27 pressed on the turning-out side at the time of backward moving by the disc 11 presses, on the turning-out side at the time of backward moving, the turning-in-side side pushing spring 131 of the turning-in-side pad spring 24 illustrated in FIG. 7 on the outer side with the turning-in-side friction pad portion 184(a) of the main body portion 185 on the turning-in side at the time of forward moving, which is the turning-out side at the time of backward moving, and elastically deforms the turning-in-side side pushing spring 131. Thereafter, the second friction pad 27 abuts the apex of the curve of the wall plate portion 113 of the turning-in-side pad spring 24 on the outer side, at the center of the ear portion 176 on the turning-out side at the time of backward moving in the direction of the reference line in the disc radial direction. Thereafter, the ear portion 176 presses and elastically deforms the wall plate portion 113 on the turning-out side at the time of backward moving, at its distal end surface portion 193. Thereafter, the wall plate portion 113 finally becomes a flat plate shape and is brought into a state where the wall plate portion 113 comes into surface contact with the distal end surface portion 193 of the ear portion 176 of the second friction pad 27 on the turning-out side at the time of backward moving and the third surface portion 63 which is a torque receiving surface of the torque receiving portion 60 of the third attachment portion 51.

For the disc brake 10, this state is a second state in which the clearance S between the distal end surface portion 193 of the ear portion 176 of the second friction pad 27 on the turning-out side at the time of backward moving and the wall plate portion 113 of the turning-in-side pad spring 24 on the outer side is filled due to the movement of the second friction pad 27. Once the second state is achieved, the torque receiving portion 60 of the third attachment portion 51 of the attachment member 20 on the turning-out side at the time of backward moving and on the outer side receives a braking torque from the ear portion 176 of the second friction pad 27 on the turning-out side at the time of backward moving via the wall plate portion 113 of the turning-in-side pad spring 24 on the outer side in the third surface portion 63.

Once the braking is released, the first friction pad 26 moves to be separated from the disc 11 in the disc axis direction with the biasing force of the turning-in-side return spring 196(a) and the turning-out-side return spring 196(b) illustrated in FIG. 3, both of which are attached to the first friction pad 26, and the biasing force of the turning-in-side side pushing spring 131 on the inner side and the turning-out-side side pushing spring 152 on the inner side illustrated in FIG. 5, both of which abut the first friction pad 26, similarly to the above description in the disc brake 10. Along with this, the second friction pad 27 moves to be separated from the disc 11 in the disc axis direction with the biasing force of the turning-in-side return spring 196(a) and the turning-out-side return spring 196(b) illustrated in FIG. 6, both of which are attached to the second friction pad 27, and the biasing force of the turning-in-side side pushing spring 131 on the outer side and the turning-out-side side pushing spring 152 on the outer side illustrated in FIG. 5, both of which abut the second friction pad 27.

Japanese Unexamined Patent Application, First Publication No. 2000-161395 described above discloses using pad clips in a disc brake including a friction pad that faces a rotor and a support that supports a braking force from the friction pad. The pad clips are attached between a side edge portion of the friction pad and an anchor portion of the support, support the friction pad, and generate a returning force in a direction of separating the friction pad from the rotor. Then, the disc brake includes, as the pad clips, a pad clip disposed on the turning-in-side of the rotor and a pad clip disposed on the turning-out side of the rotor. Incidentally, it is desirable to curb dragging in which the friction pad comes into contact with the disc in a brake released state in the disc brake.

In the disc brake 10 according to the first embodiment, the turning-in-side return spring 196(a) and the turning-out-side return spring 196(b), both of which bias the first friction pad 26 in the direction away from the disc 11 in the disc axis direction, are fixed to the first friction pad 26. Also, in the disc brake 10, the turning-in-side return spring 196(a) and the turning-out-side return spring 196(b), both of which bias the second friction pad 27 in the direction away from the disc 11 in the disc axis direction are fixed to the second friction pad 27. Moreover, in the disc brake 10, the turning-in-side pad spring 24 includes the turning-in-side side pushing spring 131 that biases the first friction pad 26 in the direction away from the disc 11 in the disc axis direction. Furthermore, in the disc brake 10, the turning-in-side pad spring 24 includes the turning-in-side side pushing spring 131 that biases the second friction pad 27 in the direction away from the disc 11 in the disc axis direction. Also, in the disc brake 10, the turning-out-side pad spring 25 includes the turning-out-side side pushing spring 152 that biases the first friction pad 26 in the direction away from the disc 11 in the disc axis direction. Additionally, in the disc brake 10, the turning-out-side pad spring 25 includes the turning-out-side side pushing spring 152 that biases the second friction pad 27 in the direction away from the disc 11 in the disc axis direction. With these configurations, the disc brake 10 can satisfactorily separate the first friction pad 26 and the second friction pad 27 from the disc 11 in the disc axis direction and to curb dragging in the brake released state.

Also, in the disc brake 10, the second biasing force that the turning-out-side side pushing spring 152 generates to bias the turning-out-side friction pad portion 184(b) of the first friction pad 26 in the direction away from the disc 11 in the disc axis direction is smaller than the first biasing force that the turning-in-side side pushing spring 131 generates to bias the turning-in-side friction pad portion 184(a) of the first friction pad 26 in the direction away from the disc 11 in the disc axis direction. Therefore, the disc brake 10 can further separate the first friction pad 26 on the turning-in side at the time of forward moving as compared with the first friction pad 26 on the turning-out side at the time of forward moving from the disc 11 in the disc axis direction in the brake released state. Therefore, movement of the first friction pad 26 to approach the disc 11 due to a wedge effect of the rotating disc 11 is curbed even if the first friction pad 26 comes into contact with the rotating disc 11 at the time of forward moving due to shaking or the like of the disc 11 in the brake released state in the disc brake 10. The disc brake 10 can thus further curb dragging of the first friction pad 26.

Also, in the disc brake 10, the second biasing force that the turning-out-side side pushing spring 152 generates to bias the turning-out-side friction pad portion 184(b) of the second friction pad 27 in the direction away from the disc 11 in the disc axis direction is smaller than the first biasing force that the turning-in-side side pushing spring 131 generates to bias the turning-in-side friction pad portion 184(a) of the second friction pad 27 in the direction away from the disc 11 in the disc axis direction. Therefore, the disc brake 10 can further separate the second friction pad 27 on the turning-in side at the time of forward moving as compared with the second friction pad 27 on the turning-out side at the time of forward moving from the disc 11 in the disc axis direction in the brake released state. Therefore, moving of the second friction pad 27 to approach the disc 11 due to the wedge effect of the rotating disc 11 is curbed even if the second friction pad 27 comes into contact with the rotating disc 11 at the time of forward moving due to shaking or the like of the disc 11 in the brake released state in the disc brake 10. The disc brake 10 can thus further curb dragging of the second friction pad 27.

Also, the turning-in-side return spring 196(a) and the turning-out-side return spring 196(b), both of which are fixed to the first friction pad 26, have the same properties in the disc brake 10. Additionally, the turning-in-side return spring 196(a) and the turning-out-side return spring 196(b), both of which are fixed to the second friction pad 27, have the same properties in the disc brake 10. Furthermore, the four return springs, namely the turning-in-side return spring 196(a) and the turning-out-side return spring 196(b), both of which are fixed to the first friction pad 26, and the turning-in-side return spring 196(a) and the turning-out-side return spring 196(b), both of which are fixed to the second friction pad 27, have the same properties. Therefore, it is possible to use common components, and it is not necessary to separately produce the return springs 196 in units of sub-assemblies. Therefore, it is possible to reduce costs for the disc brake 10. Note that the spring constant of the turning-in-side return spring 196(a) fixed to the first friction pad 26 may be set to be larger than the spring constant of the turning-out-side return spring 196(b) fixed to the first friction pad 26. In this manner, movement of the first friction pad 26 to approach the disc 11 due to the wedge effect of the rotating disc 11 is further curbed. It is thus possible to further curb dragging of the first friction pad 26. Additionally, the spring constant of the turning-in-side return spring 196(a) fixed to the second friction pad 27 may be set to be larger than the spring constant of the turning-out-side return spring 196(b) fixed to the second friction pad 27. In this manner, movement of the second friction pad 27 to approach the disc 11 due to the wedge effect of the rotating disc 11 is further curbed. It is thus possible to further curb dragging of the second friction pad 27.

Also, in the disc brake 10, the size of the clearance between the turning-out-side ear portion 176(b) of the first friction pad 26 on the turning-out side at the time of forward moving and the turning-out-side ear accommodating portion 75(b) in which the turning-out-side ear portion 176(b) is accommodated in the attachment member 20 in the disc rotation direction is smaller than the size of the clearance S between the turning-in-side ear portion 176(a) of the first friction pad 26 on the turning-in side at the time of forward moving and the turning-in-side ear accommodating portion 75(a) in which the turning-in-side ear portion 176(a) is accommodated in the attachment member 20 in the disc rotation direction. In this manner, the disc brake 10 can curb hitting sound generated between the turning-out-side ear portion 176(b) of the first friction pad 26 on the turning-out side at the time of forward moving and the turning-out-side ear accommodating portion 75(b) of the attachment member 20 at the time of braking during forward traveling.

In addition, in the disc brake 10, the size of the clearance between the turning-out-side ear portion 176(b) of the second friction pad 27 on the turning-out side at the time of forward moving and the turning-out-side ear accommodating portion 75(b) in which the turning-out-side ear portion 176(b) is accommodated in the attachment member 20 in the disc rotation direction is smaller than the clearance S between the turning-in-side ear portion 176(a) of the second friction pad 27 on the turning-in side at the time of forward moving and the turning-in-side ear accommodating portion 75(a) in which the turning-in-side ear portion 176(a) is accommodated in the attachment member 20 in the disc rotation direction. In this manner, the disc brake 10 can curb hitting sound generated between the turning-out-side ear portion 176(b) of the second friction pad 27 on the turning-out side at the time of forward moving and the turning-out-side ear accommodating portion 75(b) of the attachment member 20 at the time of braking during forward traveling.

Also, in the disc brake 10, the turning-in-side returning force which is a resultant force of the turning-in-side return spring 196(a) and the turning-in-side pad spring 24 to bias the turning-in-side friction pad portion 184(a) of the first friction pad 26 in the direction away from the disc 11 in the disc axis direction is larger than the turning-out-side returning force which is a resultant force of the turning-out-side return spring 196(b) and the turning-out-side pad spring 25 to bias the turning-out-side friction pad portion 184(b) of the first friction pad 26 in the direction away from the disc 11 in the disc axis direction. Therefore, the turning-in-side friction pad portion 184(a) on the turning-in side at the time of forward moving is further separated as compared with the turning-out-side friction pad portion 184(b) on the turning-out side at the time of forward moving from the disc 11 in the disc axis direction in the first friction pad 26. In this manner, movement of the first friction pad 26 to approach the disc 11 due to the wedge effect of the rotating disc 11 is further curbed in the disc brake 10. Therefore, the disc brake 10 can further curb dragging of the first friction pad 26.

Moreover, in the disc brake 10, the turning-in-side returning force which is a resultant force of the turning-in-side return spring 196(a) and the turning-in-side pad spring 24 to bias the turning-in-side friction pad portion 184(a) of the second friction pad 27 in the direction away from the disc 11 in the disc axis direction is larger than the turning-out-side returning force which is a resultant force of the turning-out-side return spring 196(b) and the turning-out-side pad spring 25 to bias the turning-out-side friction pad portion 184(b) of the second friction pad 27 in the direction away from the disc 11 in the disc axis direction. Therefore, the turning-in-side friction pad portion 184(a) on the turning-in-side at the time of forward moving is further separated as compared with the turning-out-side friction pad portion 184(b) on the turning-out side at the time of forward moving from the disc 11 in the disc axis direction in the second friction pad 27. In this manner, movement of the second friction pad 27 to approach the disc 11 due to the wedge effect of the rotating disc 11 is further curbed in the disc brake 10. Therefore, the disc brake 10 can further curb dragging of the second friction pad 27.

Also, the turning-in-side side pushing spring 131 of the pad support portion 101 of the turning-in-side pad spring 24 on the inner side is disposed at the first friction pad 26 on the outward side of the turning-in-side ear portion 176(a) in the disc radial direction in the disc brake 10. The disc brake 10 can thus reduce a rotation moment of the first friction pad 26 generated at the time of braking during forward moving of the vehicle. Therefore, it is possible to curb generation of strange noise between the first friction pad 26 and the attachment member 20 at the time of braking during forward traveling of the vehicle. Also, the turning-in-side side pushing spring 131 of the pad support portion 101 of the turning-in-side pad spring 24 on the outer side is disposed at the second friction pad 27 on the outward side of the turning-in-side ear portion 176(a) in the disc radial direction in the disc brake 10. The disc brake 10 can thus reduce a rotation moment of the second friction pad 27 generated at the time of braking during forward moving of the vehicle. Therefore, it is possible to curb generation of strange noise between the second friction pad 27 and the attachment member 20 at the time of braking during forward moving of the vehicle. Note that the turning-in-side side pushing spring 131 of the pad support portion 101 of the turning-in-side pad spring 24 on the inner side can also be disposed at the first friction pad 26 on the inward side of the turning-in-side ear portion 176(a) in the disc radial direction. Moreover, the turning-in-side side pushing spring 131 of the pad support portion 101 of the turning-in-side pad spring 24 on the outer side can also be disposed at the second friction pad 27 on the inward side of the turning-in-side ear portion 176(a) in the disc radial direction.

Also, the turning-out-side side pushing spring 152 of the pad support portion 151 of the turning-out-side pad spring 25 on the inner side is disposed at the first friction pad 26 on the outward side of the turning-out-side ear portion 176(b) in the disc radial direction in the disc brake 10. Therefore, the disc brake 10 can reduce a rotation moment of the first friction pad 26 generated at the time of braking during backward moving of the vehicle. Therefore, it is possible to curb generation of strange noise between the first friction pad 26 and the attachment member 20 at the time of braking during backward moving of the vehicle. Moreover, the turning-out-side side pushing spring 152 of the pad support portion 151 of the turning-out-side pad spring 25 on the outer side is disposed at the second friction pad 27 on the outward side of the turning-out-side ear portion 176(b) in the disc radial direction in the disc brake 10. Therefore, the disc brake 10 can reduce a rotation moment of the second friction pad 27 generated at the time of braking during backward moving of the vehicle. It is thus possible to curb generation of strange noise between the second friction pad 27 and the attachment member 20 at the time of braking during backward moving of the vehicle. Note that the turning-out-side side pushing spring 152 of the pad support portion 151 of the turning-out-side pad spring 25 on the inner side can also be disposed at the first friction pad 26 on the inward side of the turning-out-side ear portion 176(b) in the disc radial direction. Also, the turning-out-side side pushing spring 152 of the pad support portion 151 of the turning-out-side pad spring 25 on the outer side can also be disposed at the second friction pad 27 on the inward side of the turning-out-side ear portion 176(b) in the disc radial direction.

Also, the turning-in-side pad spring 24 includes the turning-in-side pushing-up spring 121(a) that biases the turning-in-side ear portion 176(a) of the first friction pad 26 on the outward side in the disc radial direction in the disc brake 10. Therefore, the disc brake 10 can curb rattling of the first friction pad 26 in a non-braking state and to curb generation of strange noise caused by the rattling. Moreover, the turning-in-side pad spring 24 includes the turning-in-side pushing-up spring 121(a) that biases the turning-in-side ear portion 176(a) of the second friction pad 27 on the outward side in the disc radial direction in the disc brake 10. Therefore, the disc brake 10 can curb rattling of the second friction pad 27 in a non-braking state and to curb generation of strange noise caused by the rattling.

Also, the turning-out-side pad spring 25 includes the turning-out-side pushing-up spring 121(b) that biases the turning-out-side ear portion 176(b) of the first friction pad 26 on the outward side in the disc radial direction in the disc brake 10. Therefore, the disc brake 10 can curb ratting of the first friction pad 26 in a non-braking state and curb generation of strange noise caused by the rattling. Moreover, the turning-out-side pad spring 25 includes the turning-out-side pushing-up spring 121(b) that biases the turning-out-side ear portion 176(b) of the second friction pad 27 on the outward side in the disc radial direction in the disc brake 10. Therefore, the disc brake 10 can thus curb rattling of the second friction pad 27 in a non-braking state and can curb generation of strange noise caused by the ratting.

Also, the turning-in-side pad spring 24 on the turning-in-side at the time of the forward moving includes the turning-in-side side pushing spring 131 and the guide recessed portion 120, both of which are on the outer side, in the disc brake 10. The turning-in-side side pushing spring 131 of the turning-in-side pad spring 24 on the outer side elastically supports the second friction pad 27 in the disc rotation direction. The guide recessed portion 120 of the turning-in-side pad spring 24 on the outer side is offset in the disc radial direction with respect to the turning-in-side side pushing spring 131 on the outer side, covers the torque receiving portion 60 on the outer side, and elastically supports the second friction pad 27 in the disc rotation direction. Also, the disc brake 10 has the first state and the second state on the outer side. In the first state on the outer side, the turning-in-side side pushing spring 131 that is one of the turning-in-side side pushing spring 131 and the guide recessed portion 120, both of which are on the outer side of the turning-in-side pad spring 24, abuts the second friction pad 27, and the guide recessed portion 120 as the other one of them has the clearance S between the wall plate portion 113 and the second friction pad 27. In the second state on the outer side, the clearance S is filled due to movement of the second friction pad 27. Therefore, when the disc brake 10 is brought into a braking state at the time of backward moving from a braking state at the time of forward moving of the vehicle, the second friction pad 27 moves to the turning-out side at the time of backward moving from the first state on the outer side and elastically deforms the turning-in-side side pushing spring 131 of the turning-in-side pad spring 24 on the outer side. Thereafter, the second friction pad 27 elastically deforms the turning-in-side side pushing spring 131 and the wall plate portion 113 of the guide recessed portion 120, both of which are on the outer side of the turning-in-side pad spring 24, together, and the second state where the clearance S between the wall plate portion 113 and the second friction pad 27 is filled is achieved. Therefore, the turning-in-side pad spring 24 is elastically deformed in a stepwise manner and absorbs energy of collision of the second friction pad 27 against the attachment member 20. As a result, the disc brake 10 can curb generation of hitting sound or strange sound such as so-called cronk sound between the second friction pad 27 and the attachment member 20 due to the second friction pad 27 moving inside the attachment member 20 when the braking state at the time of backward moving is achieved from the braking state at the time of forward moving of the vehicle.

Also, the turning-in-side pad spring 24 on the turning-in side at the time of forward moving includes the turning-in-side side pushing spring 131 and the guide recessed portion 120, both of which are on the inner side, in the disc brake 10. The turning-in-side side pushing spring 131 of the turning-in-side pad spring 24 on the inner side elastically supports the first friction pad 26 in the disc rotation direction. The guide recessed portion 120 of the turning-in-side pad spring 24 on the inner side is offset in the disc radial direction with respect to the turning-in-side side pushing spring 131 on the inner side, covers the torque receiving portion 60 on the inner side, and elastically supports the first friction pad 26 in the disc rotation direction. Also, the disc brake 10 has the first state and the second state on the inner side as well. In the first state on the inner side, the turning-in-side side pushing spring 131 that is one of the turning-in-side side pushing spring 131 and the guide recessed portion 120, both of which are on the inner side in the turning-in-side pad spring 24, abuts the first friction pad 26, and the guide recessed portion 120 which is the other one of them has a clearance between the wall plate portion 113 and the first friction pad 26. In the second state on the inner side, the clearance is filled due to movement of the first friction pad 26. Therefore, when the disc brake 10 is brought into the braking state at the time of backward moving from the braking state at the time of forward moving of the vehicle, the first friction pad 26 moves to the turning-out side at the time of backward moving from the first state on the inner side and elastically deforms the turning-in-side side pushing spring 131 of the turning-in-side pad spring 24 on the inner side. Thereafter, the first friction pad 26 elastically deforms the turning-in-side side pushing spring 131 and the wall plate portion 113 of the guide recessed portion 120, both of which are on the inner side of the turning-in-side pad spring 24, together, and the second state in which the clearance between the wall plate portion 113 and the first friction pad 26 is filled is achieved. Therefore, the turning-in-side pad spring 24 is elastically deformed in a stepwise manner and absorbs energy of collision of the first friction pad 26 against the attachment member 20. As a result, the disc brake 10 can curb generation of hitting sound or strange noise such as so-called cronk sound between the first friction pad 26 and the attachment member 20 due to the first friction pad 26 moving inside the attachment member 20 when the braking state at the time of backward moving is achieved from the braking state at the time of forward moving of the vehicle.

The disc brake 10 can press the second friction pad 27 on the turning-out side in the disc rotation direction at the time of forward moving with the turning-in-side side pushing spring 131 on the turning-in-side pad spring 24 on the outer side by being brought into the first state in the non-braking state. Therefore, the disc brake 10 can curb generation of strange noise between the second friction pad 27 and the attachment member 20 due to the second friction pad 27 moving on the turning-out side in the disc rotation direction at the time of forward moving inside the attachment member 20 at the time of braking from the non-braking state during forward moving of the vehicle.

Also, the disc brake 10 can keep the first friction pad 26 pressed on the turning-out side in the disc rotation direction at the time of forward moving with the turning-in-side side pushing spring 131 of the turning-in-side pad spring 24 on the inner side by being brought into the first state in the non-braking state. Therefore, the disc brake 10 can curb generation of strange sound between the first friction pad 26 and the attachment member 20 due to the first friction pad 26 moving on the turning-out side in the disc rotation direction at the time of forward moving inside the attachment member 20 at the time of braking from the non-braking state during forward moving of the vehicle.

The disc brake 10 presses the second friction pad 27 on the turning-out side in the disc rotation direction at the time of forward moving only by the turning-in-side side pushing spring 131 that is one of the turning-in-side side pushing spring 131 and the wall plate portion 113 of the guide recessed portion 120, both of which are on the outer side of the turning-in-side pad spring 24, by being brought into the first state at the time of releasing of the braking. Therefore, the disc brake 10 can reduce a frictional force between the second friction pad 27 and the guide recessed portion 120 of the turning-out-side pad spring 25 on the outer side at the time of releasing of the braking and curb dragging of the second friction pad 27 to the disc 11 at the time of releasing of the braking.

Also, the disc brake 10 presses the first friction pad 26 on the turning-out side in the disc rotation direction at the time of forward moving only by the turning-in-side side pushing spring 131 that is one of the turning-in-side side pushing spring 131 and the wall plate portion 113 of the guide recessed portion 120, both of which are on the inner side of the turning-in-side pad spring 24, by being brought into the first state at the time of releasing of the braking. Therefore, the disc brake 10 can reduce a frictional force between the first friction pad 26 and the guide recessed portion 120 of the turning-out-side pad spring 25 on the inner side at the time of releasing the braking and to curb dragging of the first friction pad 26 to the disc 11 at the time of releasing of the braking.

Note that in the disc brake 10, the wall plate portion 113 of the guide recessed portion 120 that is one of the turning-in-side side pushing spring 131 and the guide recessed portion 120, both of which are on the outer side of the turning-in-side pad spring 24 may abut the second friction pad 27 and the turning-in-side side pushing spring 131 which is the other one of them may have a first state in which it has a clearance with the second friction pad 27 and a second state in which the clearance is filled due to movement of the second friction pad 27. Also, in the disc brake 10, the wall plate portion 113 of the guide recessed portion 120 that is one of the turning-in-side side pushing spring 131 and the guide recessed portion 120, both of which are on the inner side of the turning-in-side pad spring 24, abuts the first friction pad 26 and the turning-in-side side pushing spring 131 which is the other one of them may have a first state in which it has a clearance with the first friction pad 26 and a second state in which the clearance is filled due to movement of the first friction pad 26. Effects that are similar to those described above are achieved in both of these cases.

In the disc brake 10, the turning-in-side side pushing spring 131 of the turning-in-side pad spring 24 on the outer side is disposed on the side further outward in the disc radial direction than the guide recessed portion 120 on the outer side, and in the aforementioned first state, the turning-in-side side pushing spring 131 on the outer side abuts the second friction pad 27, and the guide recessed portion 120 on the outer side has a clearance S between the wall plate portion 113 and the second friction pad 27. Therefore, the disc brake 10 can press the second friction pad 27 on the turning-out side in the disc rotation direction at the time of forward moving with the turning-in-side side pushing spring 131 on the outer side disposed on the side further outward in the disc radial direction than the guide recessed portion 120 of the turning-in-side pad spring 24 on the outer side by being brought into the first state in the non-braking state. Therefore, the disc brake 10 can effectively curb rattling of the second friction pad 27 in the non-braking state during forward moving of the vehicle.

Also, in the disc brake 10, the turning-in-side side pushing spring 131 of the turning-in-side pad spring 24 on the inner side is disposed on the side further outward in the disc radial direction than the guide recessed portion 120 on the inner side, and in the aforementioned first state, the turning-in-side side pushing spring 131 on the inner side abuts the first friction pad 26, and the guide recessed portion 120 on the inner side has a clearance between the wall plate portion 113 and the first friction pad 26. Therefore, the disc brake 10 can keep the first friction pad 26 pressed on the turning-out side in the disc rotation direction at the time of forward moving with the turning-in-side side pushing spring 131 on the inner side disposed on the side further outward in the disc radial direction than the guide recessed portion 120 of the turning-in-side pad spring 24 on the inner side since the disc brake 10 becomes the first state in the non-braking state. The disc brake 10 can thus effectively curb rattling of the first friction pad 26 in the non-braking state during forward moving of the vehicle.

In the disc brake 10, the spring constant of the turning-in-side side pushing spring 131 of the turning-in-side pad spring 24 on the outer side is smaller than the spring constant of the wall plate portion 113 of the guide recessed portion 120 on the outer side. Therefore, the disc brake 10 presses the second friction pad 27 on the turning-out side in the disc rotation direction at the time of forward moving with the turning-in-side side pushing spring 131 on the outer side on which the spring constant is lower than that of the wall plate portion 113 of the guide recessed portion 120 on the outer side in the turning-in-side pad spring 24 at the time of releasing of the braking. Therefore, the disc brake 10 can further curb dragging of the second friction pad 27 to the disc 11 at the time of releasing of the braking.

Moreover, in the disc brake 10, the spring constant of the turning-in-side side pushing spring 131 of the turning-in-side pad spring 24 on the inner side is smaller than the spring constant of the wall plate portion 113 of the guide recessed portion 120 on the inner side. Therefore, the disc brake 10 presses the first friction pad 26 on the turning-out side in the disc rotation direction at the time of forward moving with the turning-in-side side pushing spring 131 on the inner side on which the spring constant is lower than that of the wall plate portion 113 of the guide recessed portion 120 on the inner side in the turning-in-side pad spring 24 at the time of releasing of the braking. Therefore, the disc brake 10 can further curb dragging of the first friction pad 26 to the disc 11 at the time of releasing of the braking.

In the disc brake 10, the guide recessed portion 120 of the turning-in-side pad spring 24 on the outer side includes the wall plate portion 113 that is curved toward the second friction pad 27 from the third surface portion 63 that serves as the torque receiving surface of the torque receiving portion 60 on the outer side and on the turning-in side at the time of forward moving. Therefore, the disc brake 10 can achieve the aforementioned effect with a simple structure in which the shape of the wall plate portion 113 of the guide recessed portion 120 of the turning-in-side pad spring 24 on the outer side is curved.

Also, in the disc brake 10, the guide recessed portion 120 of the turning-in-side pad spring 24 on the inner side includes the wall plate portion 113 that is curved toward the first friction pad 26 from the third surface portion 63 that serves as the torque receiving surface of the torque receiving portion 60 on the inner side and on the turning-in side at the time of forward moving. Therefore, the disc brake 10 can achieve the aforementioned effect with a simple structure in which the shape of the wall plate portion 113 of the guide recessed portion 120 of the turning-in-side pad spring 24 on the inner side is curved.

In the disc brake 10, the turning-in-side pad spring 24 on the turning-in side at the time of forward moving includes the turning-in-side pushing-up spring 121(a) on the outer side that abuts the second friction pad 27 and supports the second friction pad 27 on the outward side in the disc radial direction. Additionally, the apex of the curve of the wall plate portion 113 of the guide recessed portion 120 on the outer side abuts the center of the turning-in-side ear portion 176(a) disposed inside the torque receiving portion 60 of the second friction pad 27 on the turning-in side at the time of forward moving at the time of braking of backward moving of the vehicle in the turning-in-side pad spring 24. Therefore, the disc brake 10 can effectively generate a biasing force on the second friction pad 27 with the wall plate portion 113 of the guide recessed portion 120 of the turning-in-side pad spring 24 on the outer side.

Also, in the disc brake 10, the turning-in-side pad spring 24 on the turning-in side at the time of forward moving includes the turning-in-side pushing-up spring 121(a) that abuts the first friction pad 26 and supports the first friction pad 26 on the outward side in the disc radial direction. Additionally, the apex of the curve of the wall plate portion 113 of the guide recessed portion 120 on the inner side abuts the center of the turning-in-side ear portion 176(a) disposed inside the torque receiving portion 60 of the first friction pad 26 on the turning-in side at the time of forward moving at the time of braking of backward moving of the vehicle in the turning-in-side pad spring 24. Therefore, the disc brake 10 can effectively generate a biasing force on the first friction pad 26 with the wall plate portion 113 of the guide recessed portion 120 on the inner side.

### Second Embodiment

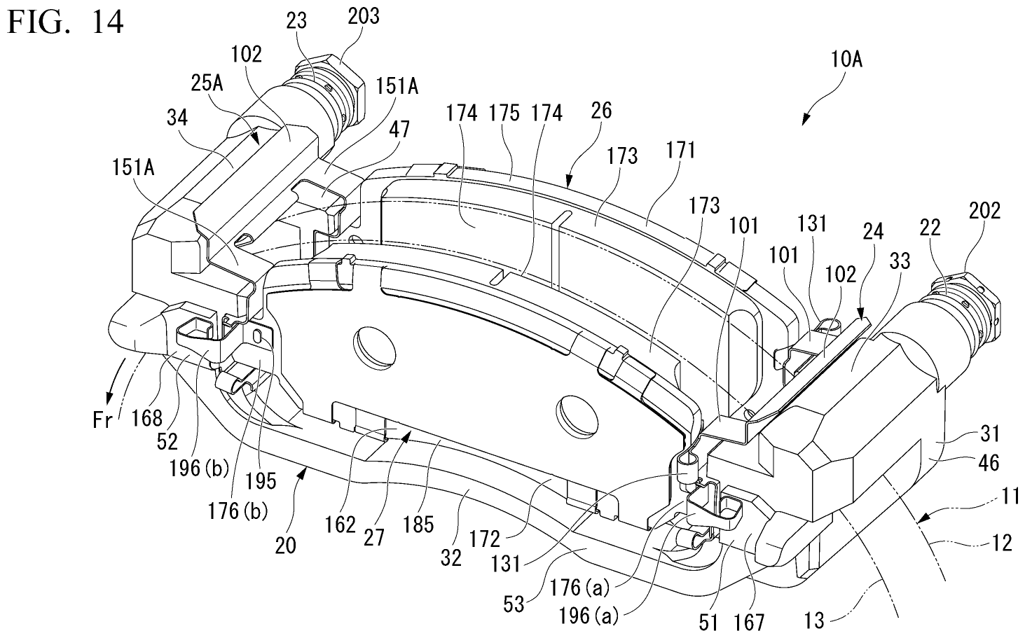

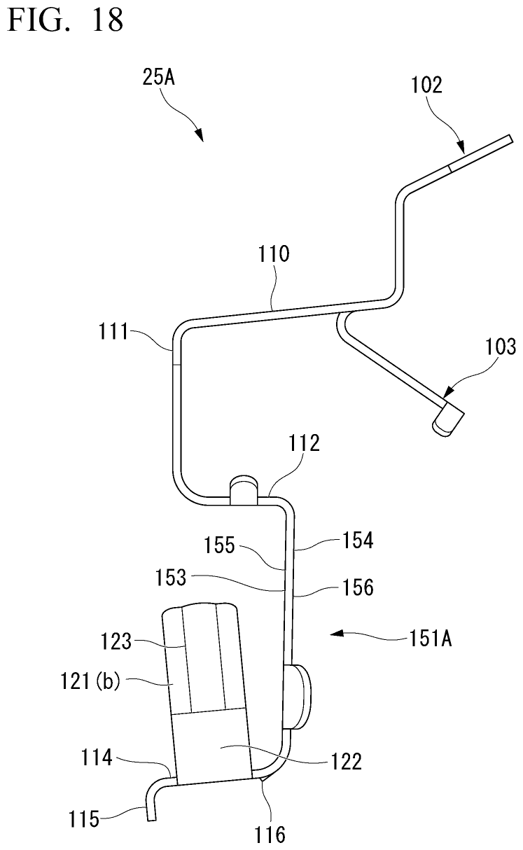

Next, differences of a second embodiment from the first embodiment will be mainly described mainly with reference to FIGS. 14 and 18. Note that sites that are common to those in the first embodiment will be denoted by the same names and the same reference signs.

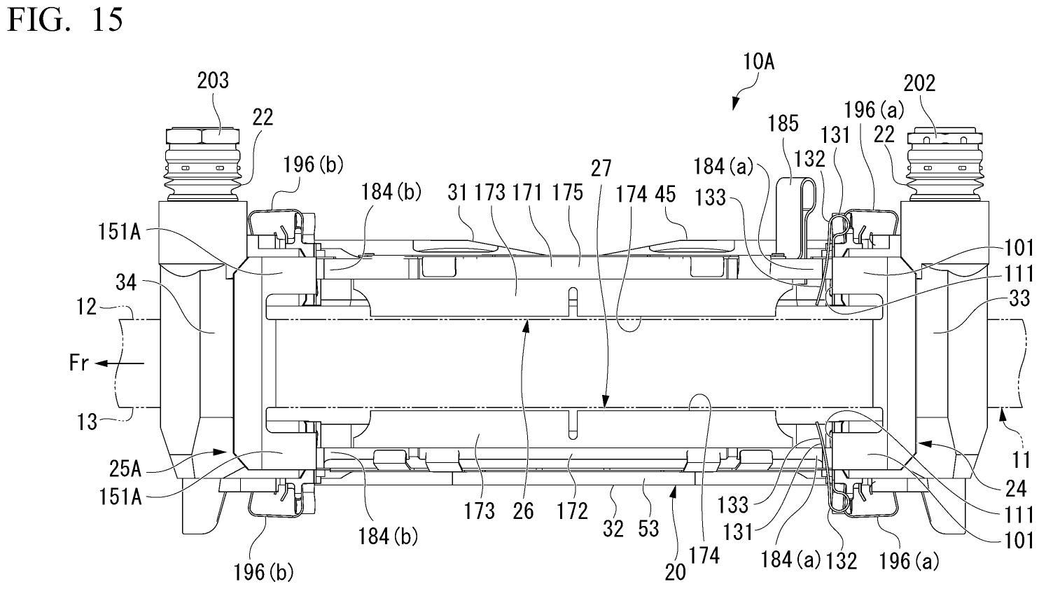

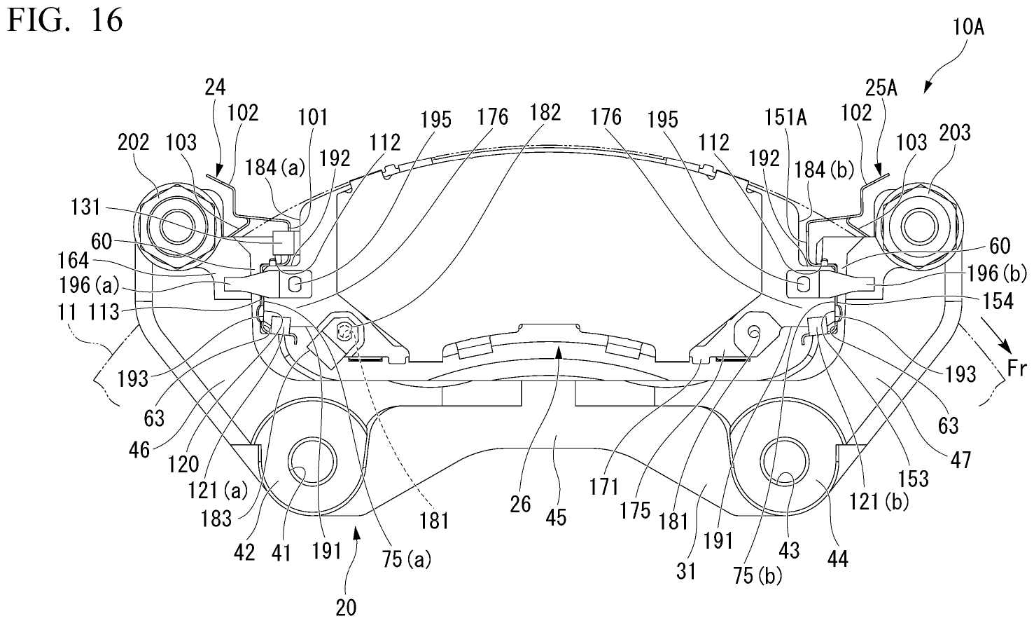

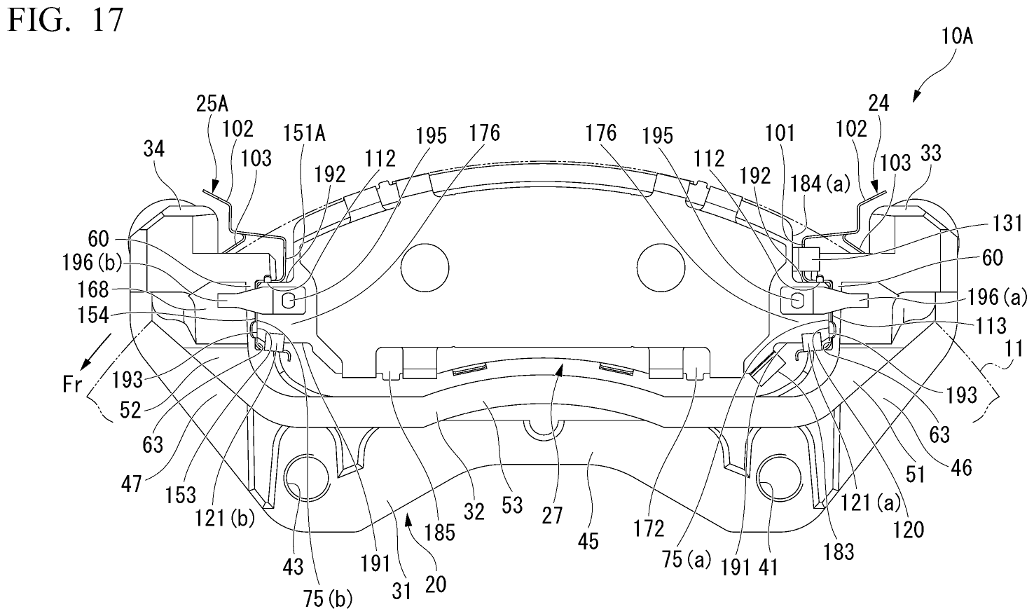

As illustrated in FIGS. 14 to 18, a disc brake 10A according to the second embodiment includes a turning-out-side pad spring 25A (pad spring) that is partially different from the turning-out-side pad spring 25 instead of the turning-out-side pad spring 25. The turning-out-side pad spring 25A is provided between a second attachment portion 47 and a fourth attachment portion 52, both of which are on a turning-out side at the time of forward moving of the attachment member 20 and a pair of first friction pad 26 and second friction pad 27 in a disc rotation direction, similarly to the turning-out-side pad spring 25.

The turning-out-side pad spring 25A includes a pair of pad support portions 151A that are partially different from the pair of pad support portions 151 instead of the pair of pad support portions 151. Both the pair of pad support portions 151A are not provided with the pair of turning-out-side side pushing springs 152 illustrated in FIG. 8. In other words, the turning-out-side pad spring 25A does not include any spring corresponding to the turning-out-side side pushing spring 152 of the turning-out-side pad spring 25 that biases the turning-out-side friction pad portion 184(b) on the turning-out side at the time of forward moving of each of the pair of first friction pad 26 and second friction pad 27, on the turning-in side at the time of forward moving and in a direction away from a disc 11 in a direction of a disc axis.

Also, in the disc brake 10A, four return springs, namely a turning-in-side return spring 196(a) and a turning-out-side return spring 196(b) which bias the first friction pad 26 in the direction away from the disc 11 and a turning-in-side return spring 196(a) and a turning-out-side return spring 196(b) which bias the second friction pad 27 in the direction away from the disc 11 have the same properties similarly to the disc brake 10.

A resultant force of the turning-in-side return spring 196(a) and the turning-in-side pad spring 24 which is a force of biasing a turning-in-side friction pad portion 184(a) of the first friction pad 26 on the turning-in side at the time of forward moving in the direction away from the disc 11 in the disc axis direction is defined as a turning-in-side returning force. Also, a force of the turning-out-side return spring 196(b) which is a force of biasing the turning-out-side friction pad portion 184(b) of the first friction pad 26 on the turning-out side at the time of forward moving in the direction away from the disc 11 in the disc axis direction is defined as a turning-out-side returning force. Moreover, the turning-in-side returning force of the first friction pad 26 is larger than the turning-out-side returning force of the first friction pad 26.

A resultant force of the turning-in-side return spring 196(a) and the turning-in-side pad spring 24 which is a force of biasing the turning-in-side friction pad portion 184(a) of the second friction pad 27 on the turning-in side at the time of forward moving in the direction away from the disc 11 in the disc axis direction is defined as a turning-in-side returning force. Also, a force of the turning-out-side return spring 196(b) which is a force of biasing the turning-out-side friction pad portion 184(b) of the second friction pad 27 on the turning-out side at the time of forward moving in the direction away from the disc 11 in the disc axis direction is defined as a turning-out-side returning force. Additionally, the turning-in-side returning force of the second friction pad 27 is larger than the turning-out-side returning force of the second friction pad 27.

The disc brake 10A according to the second embodiment achieves effects that are similar to those of the disc brake 10 according to the first embodiment. In other words, the turning-in-side return spring 196(a) and the turning-out-side return spring 196(b), both of which bias the first friction pad 26 in the direction away from the disc 11 in the disc axis direction are fixed to the first friction pad 26 in the disc brake 10A, for example. Additionally, the turning-in-side return spring 196(a) and the turning-out-side return spring 196(b), both of which bias the second friction pad 27 in the direction away from the disc 11 in the disc axis direction are fixed to the second friction pad 27 in the disc brake 10A. Moreover, the turning-in-side pad spring 24 includes a turning-in-side side pushing spring 131 that biases the first friction pad 26 in the direction away from the disc 11 in the disc axis direction in the disc brake 10A. Furthermore, the turning-in-side pad spring 24 includes a turning-in-side side pushing spring 131 that biases the second friction pad 27 in the direction away from the disc 11 in the disc axis direction in the disc brake 10A. With these configurations, the disc brake 10A can satisfactorily separate the first friction pad 26 and the second friction pad 27 from the disc 11 in the disc axis direction and to curb dragging in a brake released state.

Furthermore, the disc brake 10A does not have a spring corresponding to the turning-out-side side pushing spring 152 that biases the first friction pad 26 in the direction away from the disc 11 in the disc axis direction in the turning-out-side pad spring 25. Therefore, the disc brake 10A can further separate the first friction pad 26 on the turning-in side at the time of forward moving as compared with the first friction pad 26 on the turning-out side at the time of forward moving from the disc 11 in the disc axis direction in the brake released state. Therefore, movement of the first friction pad 26 to approach the disc 11 due to a wedge effect of the rotating disc 11 is curbed even if the first friction pad 26 comes into contact with the rotating disc 11 at the time of forward traveling due to shaking or the like of the disc 11 in the brake released state in the disc brake 10A. Therefore, the disc brake 10A can further curb dragging of the first friction pad 26.

In addition, the disc brake 10A does not have a spring that corresponds to the turning-out-side side pushing spring 152 that biases the second friction pad 27 in the direction away from the disc 11 in the disc axis direction in the turning-out-side pad spring 25. Therefore, the disc brake 10A can further separate the second friction pad 27 on the turning-in side at the time of forward moving as compared with the second friction pad 27 on the turning-out side at the time of forward moving from the disc 11 in the disc axis direction in the brake released state. Therefore, movement of the second friction pad 27 to approach the disc 11 due to the wedge effect of the rotating disc 11 is curbed even of the second friction pad 27 comes into contact with the rotating disc 11 at the time of forward traveling due to shaking or the like of the disc 11 in the brake released state in the disc brake 10A. The disc brake 10A can thus further curb dragging of the second friction pad 27.

Also, in the disc brake 10A, the turning-in-side returning force which is a resultant force of the turning-in-side return spring 196(a) and the turning-in-side pad spring 24 to bias the turning-in-side friction pad portion 184(a) of the first friction pad 26 in the direction away from the disc 11 in the disc axis direction is larger than the turning-out-side returning force of the turning-out-side return spring 196(b) to bias the turning-out-side friction pad portion 184(b) of the first friction pad 26 in the direction away from the disc 11 in the disc axis direction. Therefore, the turning-in-side friction pad portion 184(a) of the first friction pad 26 on the turning-in side at the time of forward moving is further separated as compared with the turning-out-side friction pad portion 184(b) on the turning-out side at the time of forward moving from the disc 11 in the disc axis direction. In this manner, movement of the first friction pad 26 to approach the disc 11 due to the wedge effect of the rotating disc 11 is further curbed in the disc brake 10A. The disc brake 10A can thus further curb dragging of the first friction pad 26.

Also, in the disc brake 10A, the turning-in-side returning force which is a resultant force of the turning-in-side return spring 196(a) and the turning-in-side pad spring 24 to bias the turning-in-side friction pad portion 184(a) of the second friction pad 27 in the direction away from the disc 11 in the disc axis direction is larger than the turning-out-side returning force of the turning-out-side return spring 196(b) to bias the turning-out-side friction pad portion 184(b) of the second friction pad 27 in the direction away from the disc 11 in the disc axis direction. Therefore, the turning-in-side friction pad portion 184(a) of the second friction pad 27 on the turning-in side at the time of forward moving is further separated as compared with the turning-out-side friction pad portion 184(b) on the turning-out side at the time of forward moving from the disc 11 in the disc axis direction. In this manner, movement of the second friction pad 27 to approach the disc 11 due to the wedge effect of the rotating disc 11 is further curbed in the disc brake 10A. Therefore, the disc brake 10A can further curb dragging of the second friction pad 27.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A disc brake that brakes a disc that rotates along with a wheel of a vehicle, the disc brake comprising:
an attachment member that is fixed to a wheel support portion supporting the wheel and is provided to straddle an outer peripheral side of the disc in a radial direction with respect to a rotation axis of the disc;
a caliper that is provided in the attachment member to be movable in a direction of the rotation axis;
a pair of friction pads that are provided in the attachment member and are pressed against both side surfaces of the disc by the caliper in the direction of the rotation axis;
a return spring that biases the pair of friction pads in a direction away from the disc in the direction of the rotation axis,
the return spring including a turning-in-side return spring and a turning-out-side return spring,
the turning-in-side return spring being fixed to a turning-in side of a rear surface of each of the pair of friction pads located on a side opposite to a distal end surface abutting the disc, which the disc enters while rotating in a rotation direction of the disc, and abutting a turning-in-side abutting surface portion of the attachment member on the turning-in side in the direction of the rotation axis, and
the turning-out-side return spring being fixed to a turning-out side of the rear surface of each of the pair of friction pads, which the disc exit while rotating in the rotation direction of the disc, and abutting a turning-out-side abutting surface portion of the attachment member on the turning-out side in the direction of the rotation axis; and
a pad spring that is provided between the attachment member and the pair of friction pads in the rotation direction of the disc,
the pad spring including a turning-in-side pad spring and a turning-out-side pad spring,
the turning-in-side pad spring being provided between an attachment portion of the attachment member on the turning-in side and the pair of friction pads and including a turning-in-side side pushing spring that generates a first biasing force of biasing, on the turning-out side and in a direction of the disc in the direction of the rotation axis, a turning-in-side friction pad portion located at each of the pair of friction pads on the turning-in side, and
the turning-out-side pad spring being provided between an attachment portion of the attachment member on the turning-out side and the pair of friction pads and including a turning-out-side side pushing spring, a second biasing force of biasing, on the turning-in side and in the direction of the disc in the direction of the rotation axis, a turning-out-side friction pad portion located at each of the pair of friction pads on the turning-out side being smaller than the first biasing force of the turning-in-side side pushing spring.

2. The disc brake according to claim 1, wherein the turning-in-side return spring has identical properties to properties of the turning-out-side return spring.

3. The disc brake according to claim 1, wherein the turning-in-side return spring has a higher spring constant than the turning-out-side return spring.

4. The disc brake according to claim 1,
wherein a size of a clearance between a turning-out-side ear portion of the pair of friction pads on the turning-out side and a turning-out-side ear accommodating portion, in which the turning-out-side ear portion of the attachment member is accommodated, in the rotation direction of the disc is smaller than
a size of a clearance between a turning-in-side ear portion of the pair of friction pads on the turning-in side and a turning-in-side ear accommodating portion, in which the turning-in-side ear portion of the attachment member is accommodated, in the rotation direction of the disc.

5. The disc brake according to claim 1,
wherein a turning-in-side returning force which is a resultant force of the turning-in-side return spring and the turning-in-side pad spring, which is a force of biasing the turning-in-side friction pad portion located at the pair of friction pads on the turning-in side in a direction away from the disc in the direction of the rotation axis is stronger than
a turning-out-side returning force which is a resultant force of the turning-out-side return spring and the turning-out-side pad spring, which is a force of biasing the turning-out-side friction pad portion located at the pair of friction pads on the turning-out side in a direction away from the disc in the direction of the rotation axis.

6. The disc brake according to claim 1,
wherein each of the pair of friction pads includes
a turning-out-side ear portion on the turning-out-side, and
a turning-in-side ear portion on the turning-in side,
the attachment member includes
a turning-out-side ear accommodating portion in which the turning-out-side ear portion is accommodated, and
a turning-in-side ear accommodating portion in which the turning-in-side ear portion is accommodated, and
the turning-in-side side pushing spring of the turning-in-side pad spring is disposed outside the turning-in-side ear portion in the radial direction.

7. The disc brake according to claim 6, wherein the turning-out-side side pushing spring of the turning-out-side pad spring is disposed outside the turning-out-side ear portion in the radial direction.

8. The disc brake according to claim 7,
wherein the turning-in-side pad spring includes
a turning-in-side pushing-up spring that biases the turning-in-side ear portion of the pair of friction pads on the turning-in side on the outer side in the radial direction.

9. The disc brake according to claim 7,
wherein the turning-out-side pad spring includes
a turning-out-side pushing-up spring that biases the turning-out-side ear portion of the pair of friction pads on the turning-out side on the outer side in the radial direction.

10. A disc brake that brakes a disc that rotates along with a wheel of a vehicle, the disc brake comprising:
an attachment member that is fixed to a wheel support portion supporting the wheel and is provided to straddle an outer peripheral side of the disc in a radial direction with respect to a rotation axis of the disc;
a caliper that is provided in the attachment member to be movable in a direction of the rotation axis;
a pair of friction pads that are provided in the attachment member and are pressed against both side surfaces of the disc by the caliper in the direction of the rotation axis;
a return spring that biases the pair of friction pads in a direction away from the disc in the direction of the rotation axis,
the return spring including a turning-in-side return spring and a turning-out-side return spring,
the turning-in-side return spring being fixed to a turning-in side of a rear surface of each of the pair of friction pads located on a side opposite to a distal end surface abutting the disc, which the disc enters while rotating in a rotation direction of the disc, and abutting a turning-in-side abutting surface portion of the attachment member on the turning-in side in the direction of the rotation axis, and
the turning-out-side return spring being fixed to a turning-out side of the rear surface of each of the pair of friction pads, which the disc exit while rotating in the rotation direction of the disc, and abutting a turning-out-side abutting surface portion of the attachment member on the turning-out side in the direction of the rotation axis; and
a pad spring that is provided between the attachment member and the pair of friction pads in the rotation direction of the disc,
the pad spring including a turning-in-side pad spring and a turning-out-side pad spring,
the turning-in-side pad spring being provided between an attachment portion of the attachment member on the turning-in side and the pair of friction pads and including a turning-in-side side pushing spring that biases, on the turning-out side and in a direction of the disc in the direction of the rotation axis, a turning-in-side friction pad portion located at each of the pair of friction pads on the turning-in side, and
the turning-out-side pad spring being provided between an attachment portion of the attachment member on the turning-out side and the pair of friction pads and including no spring corresponding to a turning-out-side side pushing spring that biases, on the turning-in side and in the direction of the disc in the direction of the rotation axis, a turning-out-side friction pad portion located at each of the pair of friction pads on the turning-out side.

11. The disc brake according to claim 10,
wherein a turning-in-side returning force which is a resultant force of the turning-in-side return spring and the turning-in-side pad spring, which is a force of biasing the turning-in-side friction pad portion located at the pair of friction pads on the turning-in side in a direction away from the disc in the direction of the rotation axis is stronger than
a turning-out-side returning force of the turning-out-side return spring which is a force of biasing the turning-out-side friction pad portion located at the pair of friction pads on the turning-out side in a direction away from the disc in the direction of the rotation axis.
